(19) United States
(12) Patent Application Publication
(10) Pub. No.: US 2016/0188756 A1
(43) Pub. Date: Jun. 30, 2016

(54) Deployment Strategy For Sensors Using Linked-Guard-Covers

(71) Applicant: Invent.ly LLC, Woodside, CA (US)

(72) Inventors: Hector H Gonzalez-Banos, Mountain View, CA (US); Asif Ghias, Novato, CA (US)

(21) Appl. No.: 14/684,198

(22) Filed: Apr. 10, 2015

Related U.S. Application Data
(63) Continuation-in-part of application No. 14/586,608, filed on Dec. 30, 2014.

(51) Int. Cl. G06F 17/50; G06F 17/10

(52) U.S. Cl. CPC G06F 17/5004; G06F 17/10

(57) ABSTRACT

The invention teaches an effective deployment strategy for sensing stations based on finding a minimum linked-guard-cover solution. A linked-guard-cover is based on a set-cover solution of computational geometry, however it provides coverage, while keeping the sensing stations linked or connected. The system and methods of the invention teach embodiments to deploy sensors of varying capabilities in a workspace with real-world constraints. Sensor capabilities include having sensing stations with different types of sensors operating simultaneously to provide sensing, network or other types of coverages. Constraints include having range and directional constraints on the sensors, requiring sensing stations to be placed only within certain predetermined regions or locations of the workspace, and having a limited number of a certain type of sensors available.

### RELATED APPLICATIONS

This application is a continuation-in-part of U.S. patent application Ser. No. 14/586,608 filed on Dec. 30, 2014 and incorporated herein in its entirety.

### FIELD OF THE INVENTION

This invention relates generally to the fields of computational geometry, combinatorics, set theory, linear programming, computer science, distributed/mobile sensor networks, wireless sensor networks, smart sensor networks and in particular to determining effective placement of different types of sensors in varied environments.

### BACKGROUND ART

There are a number of related disciplines with similar and sometimes conflated names such as wireless sensor networks, distributed sensor networks, mobile sensor networks, ubiquitous sensor networks, smart sensor networks that are concerned with effectively deploying various types of sensors in diverse environments for a large variety of industrial applications. It is no surprise that sensor deployment in such disciplines remains an active area of academic and industrial pursuit. With the ubiquity of sensors such as smart phones and other smart devices pervading through our daily lives, with concepts such as internet of things (IOT) maturing over the last decade, and with the interconnectedness of the world fast becoming a reality, it is no surprise that a large number of technology companies and academic institutions are spending a vast amount of resources in developing programs and products for deploying the ever increasing universe of sensors in the most effective manner possible.

In as far as devising strategies for deploying sensors, there are many schemes taught in the prior art. “A Randomized Art-Gallery Algorithm for Sensor Placement” by Hector Gonzalez-Banos et al. of Stanford University (2001) describes a placement strategy for computing a set of ‘good’ locations where visual sensing will be most effective. The sensor placement strategy relies on a randomized algorithm that solves a variant of the art-gallery problem known to those skilled in the art. The strategy finds a minimum set of guards inside a polygonal workspace from which the entire workspace boundary is visible. To better take into account the limitations of physical sensors, the algorithm computes a set of guards that satisfies incidence and range constraints.

“Coverage by directional sensors in randomly deployed wireless sensor networks” by Jing Ai et al. of Rensselaer Polytechnic Institute (2005) teaches a novel ‘coverage by directional sensor’ problem with tunable orientations on a set of discrete targets. It proposes a Maximum Coverage with Minimum Sensors (MCMS) problem in which coverage in terms of the number of targets to be covered is maximized whereas the number of sensors to be activated is minimized. The paper presents its exact Integer Linear Programming (ILP) formulation and an approximate (but computationally efficient) centralized greedy algorithm (CGA) solution. These centralized solutions are used as baselines for comparison. Then it provides a distributed greedy algorithm (DGA) solution. By incorporating a measure of the sensors residual energy into DGA, it further develops a Sensing Neighborhood Cooperative Sleeping (SNCS) protocol which performs adaptive scheduling on a larger time scale. Finally, it evaluates the properties of the proposed solutions and protocols in terms of providing coverage and maximizing network lifetime through extensive simulations.

“Selection and Orientation of Directional Sensors for Coverage Maximization” by Giordano Fusco et al. of Stony Brook University (2009) addresses the problem of selection and orientation of directional sensors with the objective of maximizing coverage area. Sensor nodes may be equipped with a ‘directional’ sensing device (such as a camera) which senses a physical phenomenon in a certain direction depending on the chosen orientation. The paper addresses the problem of selecting a minimum number of sensors and assigning orientations such that the given area (or set of target points) is k-covered (i.e., each point is covered k times). The above problem is NP-complete, and even NP-hard to approximate. The paper presents a simple greedy algorithm that delivers a solution that k-covers at least half of the target points using at most M log(kICI) sensors, where ICI is the maximum number of target points covered by a sensor and M is the minimum number of sensors required to k-cover all the given points.

In “Efficient Sensor Placement for Surveillance Problems”, Agarwal et al. of Duke University (2009) studies the problem of covering by sensors of a two-dimensional spatial region P that is cluttered with occluders. A sensor placed at a location p covers a point x in P if x lies within sensing radius r from p and x is visible from p, i.e., the segment px does not intersect any occluder. The goal is to compute a placement of the minimum number of sensors that cover P. It proposes a landmark-based approach for covering P.

In “On Sensor Placement for Directional Wireless Sensor Networks”, Osais of Carleton University, Ottawa (2009) discusses a directional sensor network that is formed by directional sensors which may be oriented toward different directions. The sensing region of a directional sensor can be viewed as a sector in a two-dimensional plane. Therefore, a directional sensor can only choose one sector (or direction) at any time instant. They discuss the placement of such directional sensors as a critical task in the planning of directional sensor networks. They also present an integer linear programming model whose goal is to minimize the number of directional sensors that need to be deployed to monitor a set of discrete targets in a sensor field. Numerical results demonstrate the viability and effectiveness of the model.

In general, the problem of sensor placement in an occluded space is well studied. Such a system 10 of prior art is illustrated in FIG. 1. System 10 comprises of several obstructions 14. Specifically, there are 6 obstructions as illustrated in FIG. 1. An effective sensor placement strategy addresses the problem of finding the optimal (minimum) number of locations where sensors, for example cameras, that need to be placed such that any part of a region of interest of system 10 is visible to at least one sensor. Such a solution in the literature is sometimes referred to as a 1-guard solution.

In general, the problem is oftentimes described in the context of a workspace or a region of interest where sensors are placed. Such a system 20 of prior art is illustrated in FIG. 2 comprising the elements of FIG. 1 but with a well-defined workspace 12 that contains obstructions 14. Note we have labeled only two such obstructions in FIG. 2 for clarity. An effective sensor placement strategy addresses the problem of finding the optimal (minimum) number of locations where sensors, for example cameras, can be placed in workspace 12 such that any part of the entire workspace is visible to at least one sensor. As mentioned, such a solution in the literature is sometimes referred to as a 1-guard solution.

A system 30 of prior art is illustrated in FIG. 3, in which sensor 16 is placed in workspace 12 as shown such that areas within workspace 12 unaffected by obstructions 14, as depicted by the hatch pattern, are visible to sensor 16 (assuming a straight line of sight visibility model for sensor 16). Note, that no other range or direction constraint is placed on the visibility model of sensor 16 as depicted in FIG. 3. Several prior art teachings describe strategies for placement of such sensors inside workspace 12 such that any part of workspace 12 is visible to at least one sensor 16 despite obstructions 14 in workspace 12.

A shortcoming of prior art teachings is that they do not provide a strategy for sensor deployment that includes multiple sensors or sensing stations, each with different sensing/visibility models and constraints. Further, the prior art assumes a simple sensing model for the sensors that is based on an individual type of sensor, rather than a composite visibility model that is based on a collection of various types of sensors on a given sensing station. A further shortcoming of the prior art is that it generally conflates the notions of ‘sensing coverage’ that is concerned with sensing a set of target sites or other sensors or sensed stations in a workspace, and ‘network coverage’ that is concerned with connecting or communicating with the target sites or other sensors or sensed stations in the workspace.

The prior art teachings are also silent about a linked-guard-cover of sensing stations that stay connected to each other, while providing coverage over a set of target sites or sensed stations. Furthermore, no corresponding algorithm for determining such a linked-guard-cover exists in the prior art.

### OBJECTS OF THE INVENTION

In view of the shortcomings of the prior art, it is an object of the present invention to teach a more effective deployment strategy for sensors than is available through the teachings of the prior art.

It is further an object of the invention to allow sensing stations having multiple types of sensors, each with its own sensing model and constraints.

It is further an object of the invention to incorporate sensing coverage, network coverage and localizability coverage simultaneously in the deployment of sensors as taught by the present invention.

It is further an object of the invention to determine a linked-guard-cover of sensing stations that can provide coverage over a set of target sites or sensed stations, while staying connected. It is also an object of the invention to disclose an algorithm for determining such a linked-guard-cover.

### SUMMARY OF THE INVENTION

The objects and advantages of the invention are given by a system and methods for determining a set of placement sites from a set of candidate sites. The candidate sites refer to the potential locations and other configuration information of sensing stations, while the placement sites determined or computed by the system comprise those candidate sites where the sensing stations should be placed or deployed in order to provide coverage according to the invention. The system further comprises a set of target sites. The target sites refer to the potential locations and configurations of sensed stations. The system further comprises zero or more obstructions that would obstruct the sensing of the sensed stations by the sensing stations. Preferably the system operates in a workspace, which can be either continuous or discretized/sampled.

Each sensing station has one or more sensing regions around it, each such sensing region likely but not necessarily existing due to individual sensors on the sensing station. The sensing region is defined as the set of all sites that are able to be sensed or communicated with, by that sensing station, despite the obstructions. The sensing region is further constrained by a sensing range and a sensing orientation of the corresponding sensing station. Subsequently, a composite sensing region for each sensing station is defined as the collection of the individual sensing regions of the sensing station.

Corresponding to a set of candidate sites, a set of ranges is defined, with the same cardinality as the set of candidate sites. Each range in the set of ranges is selected to be the subset of the set of target sites such that the sensed stations at the target sites in the subset are all able to be sensed or communicated with, by the sensing station at that candidate site corresponding to the range. As stated, the cardinality of the set of ranges is the same as the set of candidate sites being considered. The system determines the set of such candidate sites to be the placement sites (or the computed solution) based on a minimum linked-guard-cover solution for the set system comprising the set of all target sites, and the set family comprising the set of all the ranges above. A linked-guard-cover is a set of computed placement sites that provides near-optimal coverage by the sensing stations placed at those placement sites, while ensuring that every subset of sensing stations in the linked-guard-cover intersects with the sensing region of at least one other sensing station in the linked-guard-cover that is not in that subset. Such a solution is computed by the instant invention on a ‘best-effort’ basis.

In the preferred embodiment, the collection of individual sensing regions of a sensing station, called the composite sensing region, is taken to be a union of the individual sensing regions. Alternatively, the composite sensing region is taken to be an intersection of the individual sensing regions. Still in another embodiment, the composite sensing region is taken to be based on a generic set operation of the individual sensing regions of the sensing station.

Preferably, the target sites are merely the locations of interest that need to be observed. Hence, there is no sensor or device present at the location that needs to be observed in such a preferred embodiment. Instead the location or site itself is what is being sensed or observed by the sensing station. In another preferred embodiment, the set of placement sites determined by the system in the linked-guard-cover guarantees that each sensed station is able to be sensed or communicated with, by at least two sensing stations. This capability affords the determination of the location of a sensed station or a target site by triangulation. If each sensed station is able to be sensed or communicated with, by three or more sensing stations in the linked-guard-cover then this capability affords the determination of the location of a sensed station or target site by trilateration.

In another preferred embodiment, the candidate site comprises the location of the site in two, three or higher dimensions, and the angle(s) of orientation of the sensing station placed at that candidate site in two, three or higher dimensional Euclidean space respectively. Preferably, the angle(s) of orientation is/are unconstrained or omni-directional, so that the candidate site merely refers to the location of the placement of the sensing station.

Similarly, in another preferred embodiment, the target site comprises the location of the site in two, three or higher dimensions, and the angle(s) of orientation of the sensed station placed at that target site in two, three or higher dimensions respectively. Preferably, the angle(s) of orientation is/are unconstrained or omni-directional, so that the target site merely refers to the location of the placement of the sensed station.

In another embodiment, each sensed station also has one or more sensed regions around it, likely but not necessarily, as a result of the individual sensors present on the sensed station. A sensed region of a sensed station at a target site is defined as the set of all sites around that sensed station that if overlapping with the sensing region of a sensing station at a candidate site will result in that sensed station being sensed or communicated with, by that sensing station. Preferably, the sensing region of a sensing station at a candidate site and a sensed region of a sensed station at a target site are defined such that the sensing station can sense or communicate with the sensed station only if the sensed station is in the sensing region of the sensing station and the sensing station is in the sensed region of the sensed station.

Preferably, the sensed region is further constrained by a sensed range and a sensed orientation of the sensed station. Preferably, there is a composite sensed region around each sensed station that is a collection of the individual sensed regions around the sensed station. Preferably, each range in the set of ranges above is further chosen such that the candidate site corresponding to the range lies in the sensed region of the sensed stations placed at the target sites of that range.

In the preferred embodiment, the collection of individual sensed regions of a sensed station, called the composite sensed region, is taken to be a union of the individual sensed regions. Alternatively, the composite sensed region is taken to be an intersection of the individual sensed regions. Still in another embodiment, the composite sensed region is taken to be based on a generic set operation of the individual sensed regions of the sensed station.

Preferably, the candidate sites determined by the apparatus and methods of the invention overlap with the target sites. Alternatively, the candidate sites determined by the invention do not overlap with the target sites. In another advantageous embodiment there is another constraint placed on the apparatus and methods of the invention that requires the placement sites to have locations chosen from a set of predetermined locations in a workspace. Similarly, in another embodiment the constraint placed is such that the placement sites can only be chosen from a predetermined region in the workspace. Still in another preferred embodiment, there is a predetermined number of a certain type of sensors available.

In a highly preferred embodiment, the linked-guard-cover solution determined by the invention is based on the popular Greedy algorithm. Preferably the minimum linked-guard-cover solution is derived in polynomial time. In a related embodiment, the invention computes a Minimum Spanning Tree (MST), or alternatively a tree without simple cycles, from the graph having the placement sites of the linked-guard-cover as its nodes. The root of the MST or the tree can be used as the gateway node of the linked-guard-cover for external connectivity.

In another embodiment, the sensing station is a camera and the target sites are in a surveillance space that needs to be monitored. In another preferred embodiment, the sensing stations and the sensed stations are wireless sensors operating substantially in the popular 60 GHz frequency range. In still another preferred embodiment, the targets sites are objects of interest in a video, whether the video is pre-recorded or streaming. In another preferred embodiment, the sensing stations and sensed stations are people or objects, and the candidate and target sites are their coordinates of location in a geographical place or terrain. In a highly preferred set of embodiments, sensing stations and sensed stations are persons in a social graph. In such embodiments, a linked-guard-cover is computed as the set of people in the social graph that can reach a required larger set of people in the social graph, while staying reachable amongst themselves.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a sensor deployment system of the prior art for deployment of sensors in an environment with obstacles.

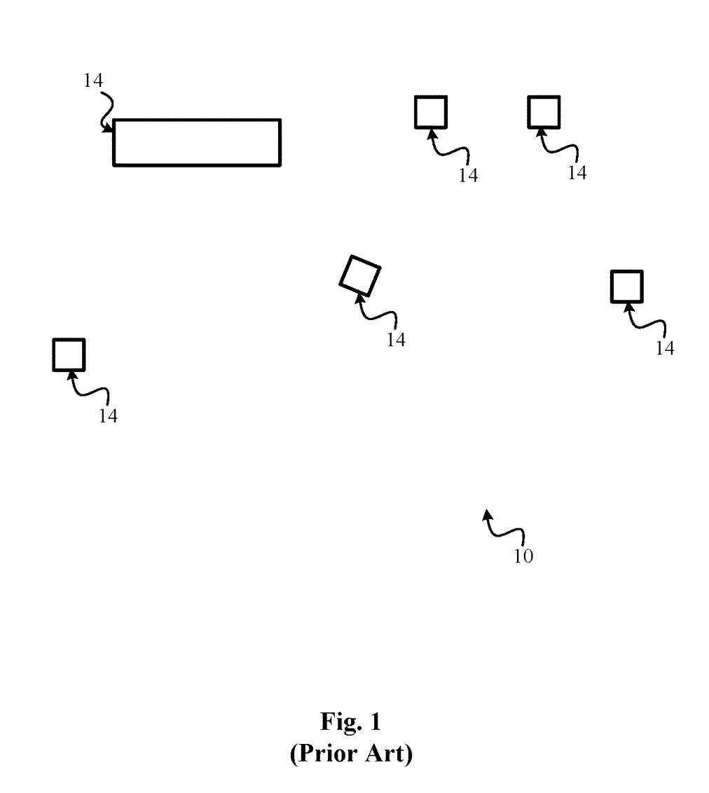

FIG. 2 is a variation of the prior art system of FIG. 1 having a well-defined workspace.

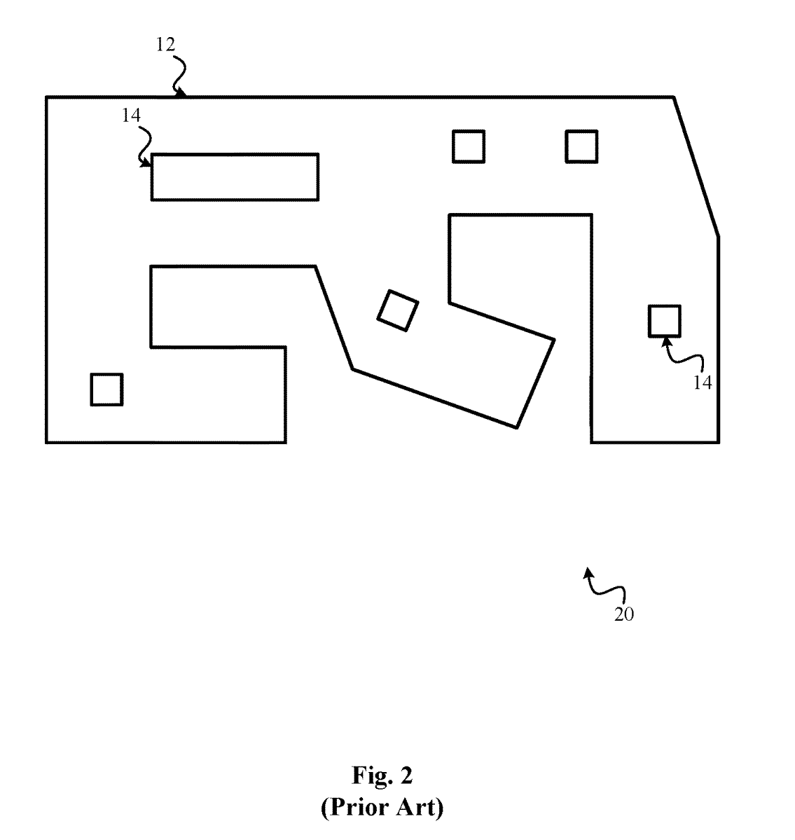

FIG. 3 is the sensor deployment system of FIG. 2 containing a sensor without range or directional constraints.

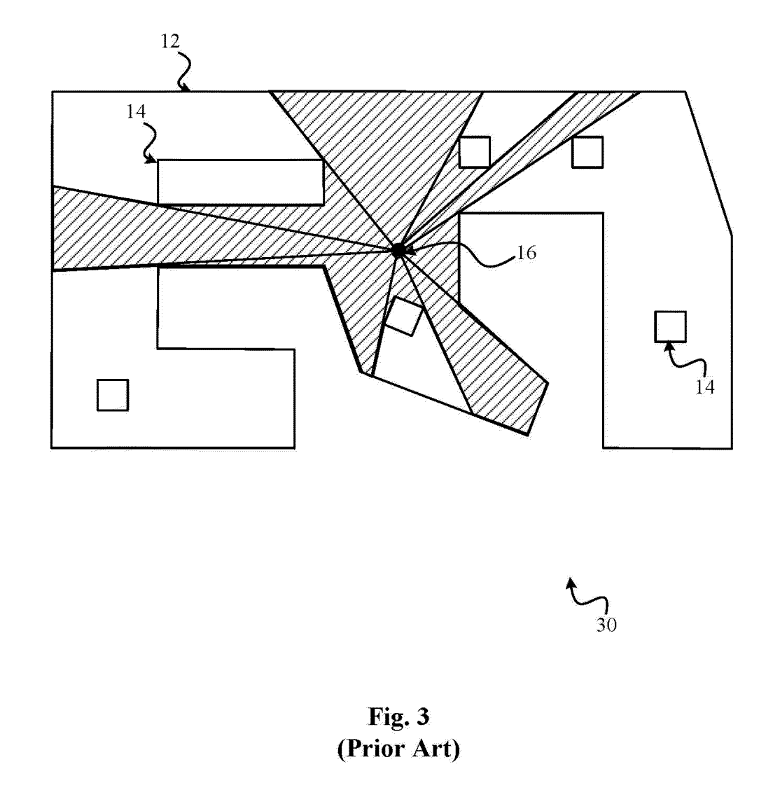

FIG. 4 is a sensor deployment system according to the present invention for deploying a variety of sensors in a workspace with obstructions.

FIG. 5 is a deployment strategy for system of FIG. 4 by finding a linked-guard-cover according to the present invention, depicting the placement of sensors to cover the entirety of the interior of the workspace, excluding obstructions, while keeping the sensors linked/connected to each other.

FIG. 6 is a deployment strategy for system of FIG. 4 based on a simple set-cover, for comparative purposes.

FIG. 7 shows a discrete sampling of the workspace of FIG. 4 and FIG. 5

FIG. 8 shows a sensor deployment system of the current invention where discretely sampled target sites are non-overlapping with the candidate sites.

FIG. 9 shows a variation of the sensor deployment system of FIG. 4 with the added constraint that sensors can only be placed in predetermined regions, and only a limited quantity of certain types of sensors are available.

FIG. 10 shows a solution to the sensor deployment system of FIG. 9 according to the present invention.

FIG. 11 shows an embodiment of the invention having a workspace and one obstacle.

FIG. 12 shows the placement of one omni-directional, limited-range sensor/guard to the embodiment shown in FIG. 11.

FIG. 13 shows the placement of another omni-directional, limited-range sensor/guard to the embodiment shown in FIG. 11-12 for providing coverage for the entirety of the workspace based on a simple cover. While the coverage is provided, the two guards are not connected.

FIG. 14 shows a linked-guard-cover for the embodiment shown in FIG. 11-13 comprising three omni-directional, limited-range sensors/guards according to the present invention.

FIG. 15 shows another embodiment having a complex workspace and eleven guards comprising a linked-guard-cover according to the invention.

FIG. 16 depicts the connected graph whose nodes are the placements sites of the guards of the embodiment of FIG. 15.

FIG. 17 illustrates a weighted graph of the embodiment of FIGS. 15-16, using the distance between the nodes as weights.

FIG. 18 illustrates a minimum spanning tree (MST) computed for the graph of FIG. 17 according to a preferred embodiment.

FIG. 19 shows an embodiment of the present invention as applied to social media by mapping sensing and sensed stations to persons in the social graph.

FIG. 20 shows a linked-guard-cover computed by the present invention for the embodiment shown in FIG. 19.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

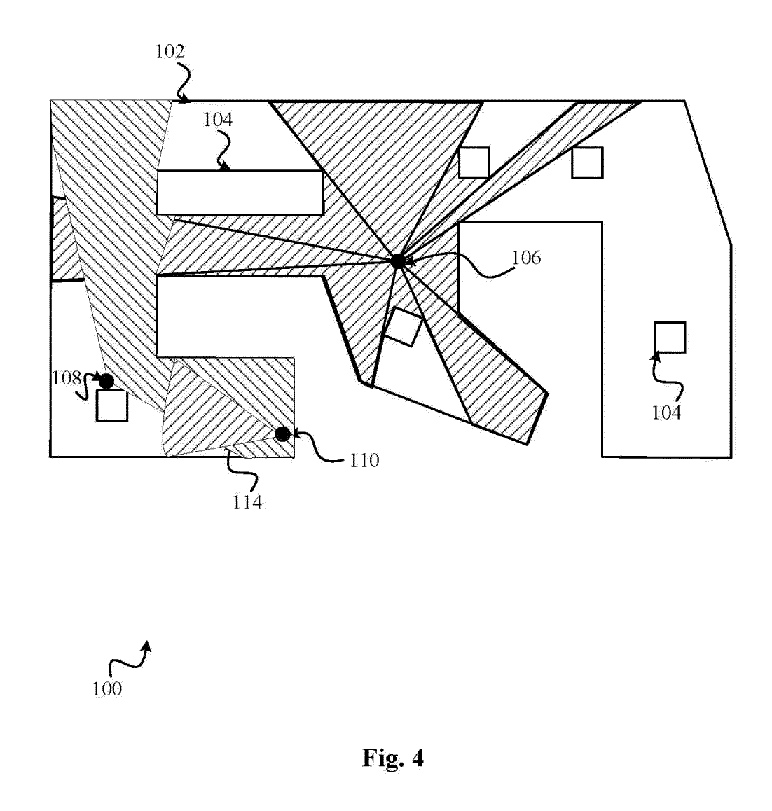

The present invention will be best understood by first reviewing the sensor deployment system 100 illustrated in FIG. 4. FIG. 4 illustrates a workspace 102 in two dimensions that has a number of obstructions 104 as indicated. FIG. 4 and associated explanation below, as well as other embodiments taught later throughout this specification will be explained taking advantage of the clarity of two dimensional illustrations where possible. Those skilled in the art will readily recognize that the below teachings are directly applicable to any higher dimensional environment and the reference to two dimensional illustrations are for convenience only. Wherever possible, three dimensional illustrations may also be referenced in the below teachings for completeness.

Workspace 102 has six obstructions 104 as indicated in FIG. 4. Before proceeding further, let us define the notion of a workspace. A workspace is any imaginary or real region of interest where we are interested in working by activities including but not limited to, such as performing observations and/or placing sensors. In the explanation of subsequent embodiments, we may define a workspace having a well-defined boundary, e.g. workspace 102 of FIG. 4, however such a definition is an optional formality, and the benefits of the invention can be accrued in any location, space or volume, without having a well-defined and formalized boundary of a workspace.

FIG. 4 also illustrates a sensing station 106 that is omni-directional, that is, it has no constraint on its orientation. Generally available radio receivers are an example of such omni-directional sensing stations or sensors. Furthermore, sensing station 106 does not have any range constraint within the context of workspace 102. In other words, the range of sensing station 106 is infinite compared to the dimensions of workspace 102. It will be obvious to those skilled in the art, that any real receiver will have a finite range of reception or a receiving range. However, for the purpose of explaining the current embodiment in regards to sensing station 106, we will assume that such range of sensing station 106 is substantially more than the dimensions of workspace 102.

Workspace 102 is assumed to comprise of a collection of sites embodied by its interior, excluding obstructions 104. In other words, obstructions 104 exist to limit or obstruct the sensing capabilities of sensing stations. More formally, any impediment in the segment connecting a point a to b such that b cannot be visible to, sensed by, communicated with, monitored, surveilled or observed by a sensing station at a, and vice versa, is regarded as an obstacle or obstruction. Generally, a site will represent a physical location in the workspace and additional configuration information of the sensor present at that location.

The terms, a site, a point or location may be used interchangeably in the following explanation, and distinction between them will be drawn where needed and appropriate. Also, in this specification, as appropriate, the term sensor may be used to refer to a sensing station as well as a sensed station, when the distinction between the two is obvious from the context. Furthermore, we may use the terms sensing station and guard interchangeably as the latter is commonly used in the art. Further still, we may use the terms sensed stations and target sites interchangeably in this specification with the knowledge that in many preferred embodiments of the invention a sensed station merely represents a site or location of interest in the workspace, and draw distinction between the terms as necessary.

Sensor deployment system 100 of FIG. 4 also has a sensor 108 that has no sensing range constraint, but has sensing orientation or a directional constraint. Further explained, the reception range of sensing station 108 is larger than the dimensions of workspace 102 and its orientation constraint is shown by the direction of its hatched cone of reception pointing north-east as indicated in FIG. 4. Such a reception cone is typical of dish antennas, for example. Finally, system 100 also shows a sensing station 110 that has both a sensing range constraint and a sensing orientation constraint. The sensing range constraint of sensing station 110 is indicated by the finite radius 114 of the cone of reception of sensing station 110, and its directional constraint is shown by the direction of the cone pointing in the west-ward direction shown in FIG. 4. According to the invention, target sites are the potential locations of sensed stations. A set of target sites in a workspace represents the locations of interest that are required to be observed. Sensed stations are potentially placed/located/situated at the target sites that can be sensed or communicated with, by sensing stations placed at candidate sites. Alternatively stated, sensed stations potentially occupy the target sites that are required to be monitored/observed.

In a highly preferred set of embodiments, the sensed stations merely represent the sites or locations in a workspace. To keep clarity, and to avoid redundancy in this explanation, when referring to these embodiments we may either refer to sensing stations as sensing/monitoring/observing/communicating with, the target sites, locations, or regions of the workspace, or alternatively we may simply refer to sensing stations as sensing/communicating with, the sensed stations, with the understanding that no sensed stations are actually present at the target sites, locations or regions of the workspace. One, such preferred embodiment as illustrated in FIG. 4, shows that the target sites comprise the entirety of the interior of workspace 102, notwithstanding obstructions 104. In other words, there is no presumption of sensed stations present in workspace 102, and the objective is to monitor the target sites comprising the interior of workspace 102. The set of such target sites is represented by set X. In other words, set X represents the set of all those sites or points in workspace 102 (not including obstructions 104), that are required to be observed by sensing stations 106, 108 and 110.

A workspace whose entirety is to be observed without further qualification, is also referred to as a continuous workspace. However, as will be further taught below, many practical applications find it useful to sample the workspace into a discrete set of target points/sites—a process called discretization, and resulting in a discretized workspace. Hence wherever below, we refer to target sites in the workspace that implies a discretization of the workspace. Note that the discretization can be extremely dense as well as sparse, as per the needs of an application. As a result, and as is customary in many texts, when we simply say that the entirety of a region or workspace is to be observed, we are making a tacit assumption that there is a dense discretization of that region or workspace, containing a large number of discrete target sites that are required to be observed. An analogous explanation also applies to candidate sites and placement sites.

According to the apparatus and methods of the main embodiments of the present invention, a sensing region exists around each sensing station when that sensing station is at a given site, called a candidate site. A candidate site would generally comprise the location information of the sensing station, the type of sensing station (106, 108 or 110) and any other ancillary information that may be needed to be associated with the candidate site. Such ancillary information may include, but is not limited to, the configuration of the sensor including its orientation, its sensing region (as will be taught below), and its any other capabilities or constraints, etc. Note, the invention refers to all such potential sites where a sensing station can be placed as candidate sites, and it refers to that subset of candidate sites where the sensing stations should be placed or deployed in order to ensure coverage according to the instant invention, as placement sites. In other words, the set of placement sites or simply placement sites refers to the ‘computed solution’ of the sensor deployment strategy as offered by the instant invention.

The location information of a candidate site may include the two-dimensional or three-dimensional coordinates in a two-dimensional or three-dimensional Euclidean space of the system. The orientation information of a sensing station may include its three axes of orientation with respect to a given coordinate system. The orientation may be represented by rotation matrices Rₓ(∝) for rotation by angle ∝ around x-axis, R_{y}(β) for rotation by angle β around y-axis and R_{z}(γ) for rotation by angle γ around z-axis, or by Euler angles or still by any other rotation convention familiar to people of skill.

Further, a skilled artisan will understand that rigid body rotations are conveniently described by three Euler angles (φ,θ,ψ). Specifically, Euler angles (φ,θ,ψ) describe how body axes (X_{b},Y_{b},Z_{b}) originally aligned with the axes (X, Y,Z) of a coordinate system transform after three rotations are applied in a pre-established order. The magnitudes of Euler angles (φ,θ,ψ) define rotation of body axes (X_{b},Y_{b},Z_{b}) in the above-defined order. A skilled artisan will also be well versed in alternative rotation conventions and descriptions thereof. These will not be delved into further detail in this specification. For clarity and ease of explanation in the below teachings, we will sometimes use the angle θ with respect to a known axis in two-dimensional space to indicate the orientation of a sensor.

Preferably the location information of a candidate site is represented by (x,y,z) coordinates in three-dimensional Euclidean space, and the orientation of the sensing station is omni-directional, that is, it is unconstrained. Preferably the location information of a candidate site is represented by just (x,y) coordinates in two-dimensional Euclidean space, and the orientation of the sensing station with respect to an axis of the two-dimensional coordinate system is represented by the angle θ. Preferably the location information of a candidate site is represented by (x,y) in two-dimensional Euclidean space, and the orientation of the sensing station is omni-directional, that is, it is unconstrained.

Note that when we refer to an unconstrained orientation of a sensing station or characterize its orientation to be omni-directional above, by that we simply mean that the sensing station is able to sense in all directions, irrespective of where it is ‘facing’. In other words, there is no front or back, or top or down, of the sensor. As will be apparent to those skilled in the art, a variety of such omni-directional sensors are commonplace in the industry, such as a 360° omni-directional or panoramic camera or an analogous microphone.

Similar to a candidate site, the location information of a target site may include its two-dimensional or three-dimensional coordinates in two-dimensional or three-dimensional Euclidean space of the system. The orientation information of a sensed station may include its three axes of orientation with respect to a given coordinate system. The orientation may be represented by rotation matrices Rₓ(∝) for rotation by angle ∝-0 around x-axis, R_{y}(β) for rotation by angle β around y-axis, R_{z}(γ) for rotation by angle γ around z-axis, or by Euler angles or still by any other rotation convention familiar to people of skill.

Preferably the location information of a target site is represented by (x,y,z) coordinates in three-dimensional Euclidean space, and the orientation of the sensed station is omni-directional, that is, it is unconstrained. Preferably the location information of a target site is represented just (x,y) coordinates in two-dimensional Euclidean space, and the orientation of the sensed station with respect to an axis of the two-dimensional coordinate system is represented by the angle θ. Preferably the location information of a target site is represented by (x,y) coordinates in two-dimensional Euclidean space, and the orientation of the sensed station is omni-directional, that is, it is unconstrained.

Similar to a sensing station, when we refer to an unconstrained orientation of a sensed station or characterize its orientation to be omni-directional above, that simply means that the sensed station is able to be sensed from all directions, irrespective of where it is ‘facing’. In other words, there is no front or back, or top or down, of the sensor. Again, as will be apparent to those skilled in the art, a variety of such omni-directional sensors are commonplace in the industry, such as an omni-directional radio transmitter with a dipole antenna.

The reader is informed that while the above explanation of the location coordinates of candidate and target sites, and sensing and sensed stations, as well as their orientations, leverages the familiar two-dimensional and three-dimensional Euclidean space, the principles of the instant invention apply equally to any higher-dimensional i.e. an n-dimensional space, where n is a whole number greater than 1. While the below teachings, illustrations and examples take advantage of the clarity of two-dimensions, that is for convenience only, and the reader is advised of the broader applicability of the teachings to three-dimensional and n-dimensional environments.

Referring to FIG. 4, according to the invention, a sensing region or a visibility region, of a sensing station at a given candidate site represents the collection of sites or locations that can be sensed by that sensing station when that sensing station is placed at that candidate site. More rigorously, a sensing region νₖ(p) around a sensing station located at a candidate site p represents the collection of target sites b where a site bενₖ(p) if a sensed station at site b is able to be sensed by the sensing station despite obstructions 104 in FIG. 4. Using the notational convenience of set theory, we succinctly state that νₖ(p)∩b≠φ, for ∀b.

Still differently put, sensing region νₖ(p) represents the region around a candidate site p in which a sensing station can sense another sensed station. In case of the preferred embodiment depicted in FIG. 4 where sensed stations merely represent the sites/points or locations of interest that are required to be observed in workspace 102, sensing region νₖ(p) of a sensing station at a candidate site p simply represents the region around a candidate site p which the sensing station can sense or monitor. Specifically, referring to FIG. 4, sensing region νₖ(p) of sensing station 106 is shown by the star-shaped polygon, or omni-directional hatched cones shown as extending from sensing station 106 in all directions. Sensing region νₖ(p) of sensor 108 is shown by the single, directed hatched cone extending in the upper-right or north-east direction from sensing station 108 and sensing region νₖ(p) of sensor 110 is represented by a single hatched cone with length or radius 114 extending left-ward or west-ward from sensing station 110.

The invention further defines a sensing range and a sensing orientation as constraints that may apply to a given sensing station. These constraints are typical of the real world sensors available in the industry. For example, while a standard radio receiver can be an omni-directional sensing station with no sensing orientation or directional constraint, in the form of a parabolic dish however, a radio receiver can also be a directional antenna. In the example illustrated in FIG. 4 containing system 100 where target sites are preferably locations or points within workspace 102, omni-directional sensing stations 106 can be a 360° omni-directional panoramic camera, while sensing station 108 can be a standard directional camera such as the one generally used in Closed-Circuit Television (CCTV) or video surveillance, and sensing station 110 can be a directional infra-red motion sensor with a limited range, such as the one used in home alarm systems.

The invention further allows a given sensing station to have multiple sensors on it, each with its own sensing region defined above. Thus according to the foregoing formal definition of a sensing region, a sensing region νₖ(p) around a sensing station located at a candidate site p represents the collection of target sites b where bενₖ(p) if a sensed station at site b is able to be sensed by sensor k of the sensing station despite obstructions 104. Differently put, a sensing region corresponding to a given sensor on a sensing station when that sensing station is placed at a candidate site represents the collection of sites or locations that can sensed by that sensor of the sensing station. Of course it is conceivable within the scope of the present invention to have a single complex sensor on a sensing station that has multiple sensing capabilities with multiple sensing regions according to the above definition.

Following directly from above, according to the present invention, a composite sensing region around a sensing station is defined as the collection of the individual sensing regions around that sensing station. As mentioned above, most likely but not necessarily, these individual sensing stations may be due to individual sensors on the sensing station. More rigorously, a composite sensing region ν(p) of a sensing station is defined as the collection of all k sensing regions νₖ(p) when the sensing station is at a candidate site p. The reader is also advised that in the ensuing explanation, we may denote the sensing region of a sensing station at a candidate site p by either νₖ(p) or simply by ν(p) with the understanding that for a lot of practical applications where k=1, and hence ν(p)=νₖ(p).

Note that for clarity in FIG. 4, the reader may observe that we have only illustrated sensing stations with apparently single sensing regions, however the teachings readily apply to sensing stations with multiple sensing regions as will be obvious to skilled artisans. Thus equivalently, sensor 106 in FIG. 4 can be thought of as composed of multiple directional sensors facing in different directions, and thus under this assumption sensor 106 has multiple sensing regions, and its composite sensing region is the one illustrated by the omni-directional hatched cones in FIG. 4.

Recall that set X of target sites represents the collection of all points of interest or targets sites that are required to be observed. Recall also that the present invention allows for the placement of sensed stations at such target sites such that the sensed stations are able to be sensed by sensing stations placed at candidate sites. Also recall, in the present embodiment shown in FIG. 4, the sensed stations just represent the locations or target sites in workspace 102 that are required to be observed, and the set X of target sites in FIG. 4 represents the entirety of the interior of workspace 102 that we are interested in observing despite obstructions 104.

According to the invention, there is a set family [symbol] comprising a set of ranges. Note, that following the standard practice of set theory, we are using the well-established term ‘range’ here to describe subsets of set X as will be further taught below. The term range from set-theory here is not be confused with the transmission range or reception range of a sensor. This unfortunate coincidence of reuse of the term in two different fields is unavoidable and any skilled artisan will be expected to understand the different notions of a ‘range’ as applied to set theory and sensors as obvious from the context in below teachings.

Each range in the set family [symbol] of ranges corresponds to a given candidate site and represents the subset of target sites from set X that are able to be sensed by a sensing station when that sensing station is placed at that candidate site. Recall from earlier teachings that a candidate site comprises the location information of sensing station, the type of sensor or sensing station deployed, and any other ancillary information about the sensing station. Thus each range in set family [symbol] corresponds to a given sensing station and represents a collection of target sites from set X that are able to be sensed by that sensing station when that sensing station is at the candidate site corresponding to that range in set family [symbol] . Of course, as a result, same sensing station at the same candidate site/location may have multiple correspondent ranges, specific to particular sets of ancillary information or configurations of that sensing station, such as including but not limited to, its orientation.

The reader is encouraged to note, that the sensor deployment strategy offered by the present invention provides an effective mechanism to deploy a variety of different ‘types’ of sensors, a distinction over prior art. Thus it is sufficient for a range to be defined as per the above definition for each type of sensing station available in system 100, in our case omni-directional sensors with no range constraint such as sensor 106, directional sensors with no range constraint such as sensor 108 and directional and range constrained sensors such as sensor 110.

More formally, according to the invention, there is a set family of ranges [symbol] ={R₁, R₂, . . . , Rₘ} whose union is the set X of all target sites, where Rᵢ is the subset of set X of those target sites that are able to be sensed by that sensing station (or that type of sensing station and its configuration as per above) when it is at a candidate site pᵢ. From here onwards, we will generally drop the distinction between individual sensing stations and individual types and configurations of sensing stations to reduce repetition in the following explanation, and will only refer to the ranges being defined for each sensing station, with the knowledge that this implies defining the ranges for each type of sensing station and for each applicable set of its ancillary information/configuration. However as needed, we may distinguish the sensor types by their reference numerals 106, 108, 110, as well as call out their specification ancillary information/configuration, in the ensuing explanation. Note that the cardinality of set [symbol] is the same as the cardinality of the set of all candidate sites {p₁, P₂, . . . , pₘ}. In other words, there is a 1-to-1 correspondence between each candidate site, and what subset of set X (or the range), a sensing station at that candidate site can sense or communicate with.

U.S. patent application Ser. No. 14/586,608 discloses the deployment strategy for deploying sensing stations 106, 108, 110 by determining a minimum set-cover for set system Σ={X, [symbol] }. A minimum set-cover for the set system with the ground set as set X and ranges given by set family [symbol] is the smallest set of placement sites chosen from the overall set of candidate sites {p₁, p₂, . . . , pₘ} for the placement of sensing stations 106, 108, 110 in workspace 102 to ensure coverage of the entirety of workspace 102 (excluding obstructions 104) such that any target site or point in workspace is sensed by at least one sensing station.

The instant invention discloses the apparatuses and methods for determining a deployment strategy for sensors based on a minimum linked-guard-cover of set system Σ={X, [symbol] }. A linked-guard-cover is a set-cover for set system Σ={X, [symbol] } such that sensing stations cover the entirety of workspace 102 when they are placed at placement sites in the set-cover, but with the added requirement that at least one sensing station in every subset of the set-cover to be ‘linked’, is able to sense or connect to at least one other sensing station in the set-cover not included in that subset of the set-cover—which is thus now called a ‘linked-guard-cover’. Explained further, a linked-guard-cover is a set of placement sites chosen from the overall set of candidate sites {p₁, p₂, . . . , pₘ} for the placement of sensing stations 106, 108, 110 in workspace 102 to ensure coverage of the entirety of workspace 102 (excluding obstructions 104) such that any target site or point in workspace 102 is sensed by at least one sensing station, with the added condition that for every subset of the linked-guard-cover, there is at least one sensing station of the linked-guard-cover not included in that subset, that is in visibility region ν(p) of at least one sensing station of the subset. The present invention discloses how to determine such a linked-guard cover of minimum size, or a minimum linked-guard-cover.

With the added requirement of sensing stations or guards to be linked in the set-cover, requiring sensing stations to be able to sense or communicate with other sensing stations per above definition, and not just the sensed stations in the workspace, sensing stations of a linked-guard-cover are assumed to be multi-functional i.e. they can obviously sense sensed stations, as well as be able to be sensed by or communicated with by other sensing stations. Several commercial transceivers have such multi-functional capability, such as wifi-routers, wifi-repeaters, cameras, radio and other wireless transceivers, etc.

The importance of finding a minimum linked-guard-cover is that sensing stations can be deployed in a manner that coverage is ensured while at the same time any sensing station is guaranteed to be reachable by any other sensing station. This guarantee is achieved by ensuring that any subset/grouping of sensing stations of a linked-guard-cover can be observed/seen/sensed or communicated with, by at least one other sensing station of the linked-guard-cover (not included in the subset/group). This requirement imposes the condition that the guards/sensing stations of a linked-guard-cover stay fully connected while providing the cover. There are many practical advantages of such a requirement. A linked-guard-cover ensures that while coverage is provided, the sensors providing the coverage are themselves not disconnected from each other. For example, this could happen in an environment where there are two sensors facing opposite directions e.g. east and west while providing coverage on target sites respectively in the east and west directions. Although a minimum set-cover would ensure that targets in the east and the west are being covered/sensed/observed/seen/heard/communicated with, there is no guarantee that the two sensors facing east and west that are providing coverage, can actually communicate with each other and potentially collaborate. This could be the case, for example, if there is an obstruction present between the two sensors.

Now let us return to our set family of ranges [symbol] ={R₁, R₂, . . . , Rₘ} whose union is the set X of all target sites corresponding to a set of candidate sites {p₁, p₂, . . . , pₘ}, where Rᵢ is the subset of set X of those target sites that a sensing station at a candidate site pᵢ with a sensing region ν(pᵢ) can sense or communicate with.

Those skilled in the art will understand that finding a minimum set-cover is an NP-hard problem. However a Greedy algorithm based solution is a popular approach to finding a near-optimal solution in polynomial time. Therefore, the minimum linked-guard-cover is preferably derived using the Greedy algorithm solution. Given sensor deployment system 100 of FIG. 4, and ground set X of all target sites, our customized or modified Greedy algorithm according to the apparatuses and methods of the instant invention, can be implemented using the following high-level pseudo-code:

High-Level Pseudo-Code:

```
  10: Given ground set X: initialize set P = {p₁, p₂, ... , pₘ} and
linked set-cover S =
  20: Choose s ∈ P that maximizes | ν(s) ∩ X| subject to ν(s) ∩ S
≠ if S ≠ //* ν(s) ∩ S ≠ implies that at least one member
of set S is in visibility/sensing region ν(s) *//
  30: Delete contents of set ν(s) from set X //* Delete all
target sites visible/sensed/able to be communicated with, by
sensing station s from ground set X * //
  40: Delete s from P
  50: Set S = S∪s
  60: If X ≠
    70: Goto 20
  80: Else
    90: Stop
  100: Fi
```

Let us also conceive of a pragmatic implementation of the above algorithm in terms of a lower-level or an implementation-level pseudo-code. The implementation-level pseudo-code is representative of the practical realization of the algorithm in terms of software engineering constructs, and will allow us the consequent determination of the observed complexity of the algorithm. Unsurprisingly, step 20 of the above high-level pseudo-code holds the key to the core aspects of the algorithm for such a determination.

Implementation-Level Pseudo-Code:

```
1. Given ground set X:
    1.1 Assign a set P = {p₁, p₂, ... , pₘ}
    1.2 Initialize set-cover S = and a set P′ =
    1.3 Construct ranges [symbol]     = {R₁, R₂, ... , Rₘ} as Rᵢ = (ν(pᵢ) ∩
    X) ∀pᵢ ∈ P
  2. Select the range R* ∈ [symbol]     with the largest cardinality in
  set [symbol]    , with corresponding candidate site s ∈ P:
    2.1 On first iteration, remove s from P
    2.2 On subsequent iterations, remove s from P′
  3. Update data structures:
    3.1 S ← S ∪ s //* this is the computed linked-guard-
    cover *//
    3.2 Delete the contents of R* from X and remove R* from
    the remaining ranges in [symbol]
    3.3 Update P′ ← P′\pᵢ corresponding to Rᵢ that was deleted
    in step 3.2.
  4. Update P and P′ as follows:
    4.1 P′ ← P′ ∪ (ν(s) ∩ P) //* add to P′ the candidate sites
    from P which can be seen/sensed/communicated with, by a
    sensing station at candidate site s *//
    4 .2 P ← P\(ν(s) ∩ P) //* remove from P the candidate
    sites which can be seen/sensed/communicated with, by a
    sensing station at candidate site s *//
  5. Iterate:
    5.1 If X ≠ and P′ ≠ return to step 2, else terminate
```

Notice that after the first iteration of the loop above, step 2. maximizes |ν(s)∩X|, subject to (ν(s)∩S)≠, corresponding to step 20 of the high-level pseudo-code presented above. It will be apparent to those skilled in the art the understanding of above notation, and how to implement or code the above variation of the popular Greedy algorithm using the specific software programming techniques, data structures and software libraries that are commonly available. Such software design and engineering details are well understood by skilled artisans. For example, an additional technique while implementing the ranges is to store the target sites visible from a sensing station in the data structure itself that is associated with the candidate site where the placement of the sensing station is being considered, as explained earlier in reference to ancillary information associated with a candidate site. Based on the contents of this data structure, it is easy to define the ranges with respect to each candidate site and sensor, and to implement the above algorithm in any programming language of choice. Further, during implementation the data structures for the ranges could be further supplemented to include the candidate sites at which other sensing stations are visible to a given sensing station.

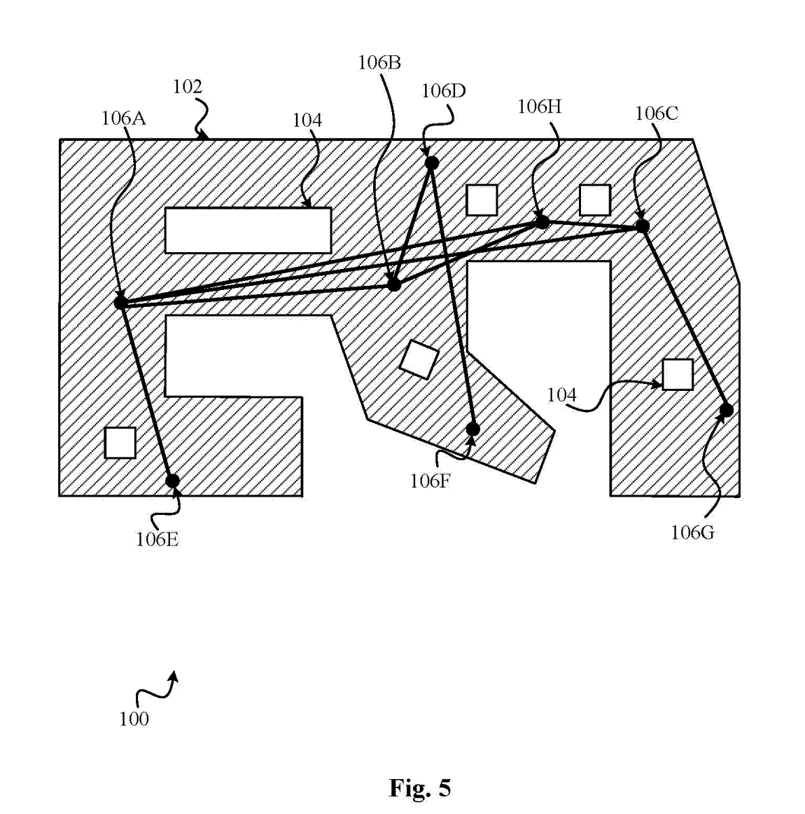

A linked-guard-cover for the example of FIG. 4, as derived by the above modified Greedy algorithm representing a sensor deployment strategy for system 100 is illustrated in FIG. 5. Recalling that set X representing all target sites was chosen to be the entirety of the interior of workspace 102, FIG. 5 represents the distribution of various types of sensors as a linked-guard-cover that, while staying fully connected, will near-optimally cover the entirety of the interior of workspace 102, despite obstructions 104. Note that since sensing station 106 of FIG. 4 is unconstrained both in direction and range, Greedy algorithm has only chosen sensing stations of this type in the solution represented in FIG. 5. That is because such a sensor would provide the largest coverage and would have a range larger than the other sensors, and hence would be the choice of the Greedy algorithm during its programmatic iterations.

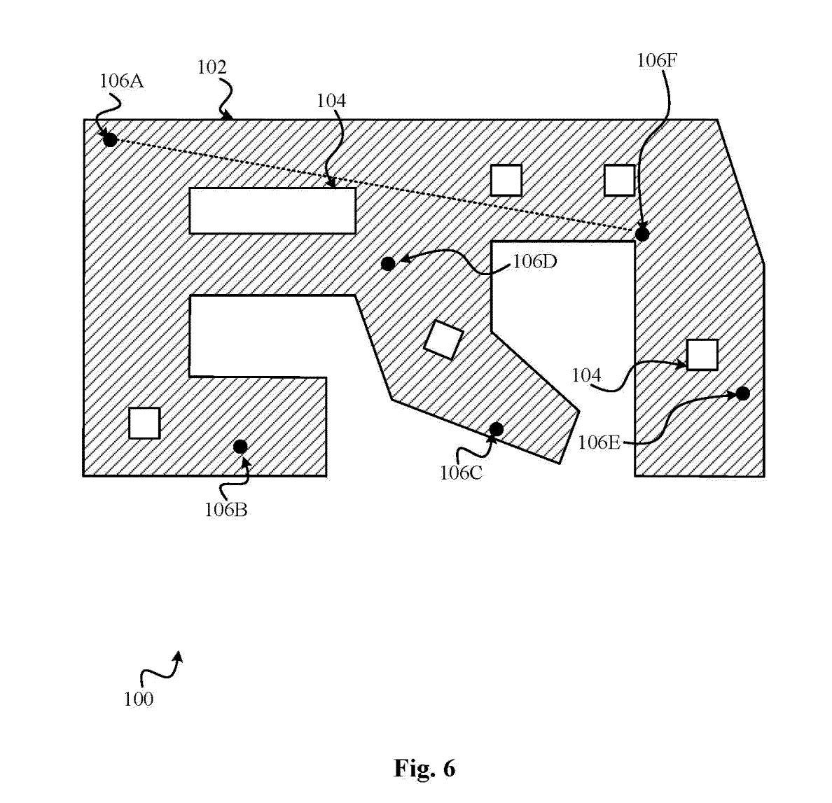

Explained further, the Greedy algorithm in each iteration will choose the range amongst remaining ranges with the largest cardinality (as shown in above pseudo-code), and hence will favor ranges corresponding to the most far-reaching or encompassing sensors, in our case sensors of type 106. Note also, that for clarity, FIG. 5 does not explicitly show the individual sensing regions of the sensors separately, but rather collectively represents the interior of workspace 102 (excluding obstructions 104) as covered by the sensors by the hatched pattern shown. For the sake of comparison, FIG. 6 represents a minimum-set-cover solution for set system Σ={X, [symbol] }, that is not a linked-guard-cover. Note that while the placement sites for sensors of type 106 to provide coverage of workspace 102 ensures that any part of workspace 102 will be covered by at least one sensor of type 106, not all sensors of type 106 can sense/communicate with each other. For example, sensing station 106B is not in the sensing region of any other sensing station 106A, 106C-F. Similarly, sensing station 106C is also ‘disconnected’ from other sensing stations 106A-B, 106D-F. In fact, only sensor 106A and 106F are linked in the solution depicted in FIG. 6, as illustrated by the dotted line connecting them.

The placement depicted in FIG. 5 comprises sensing stations 106A-H that cover the entirety of workspace 102. Further, the Greedy algorithm of the instant invention has picked placement sites for stations 106A-H in the alphabetical order i.e. 106A, 106B, . . . 106H. This is again because the Greedy algorithm by definition works in the decreasing order of the largest coverage (of the remaining target sites) by sensors at placement sites i.e. in the decreasing order of the cardinality of the ranges and hence has picked the largest set of the remaining target sites covered by a given sensing station, then the next largest set of target sites and so on. Further, FIG. 5 shows that stations 106A-H form a connected graph as shown by the dark lines connecting sensing stations/nodes 106A-H. Note further, that the graph comprising stations/nodes 106A-H shown in FIG. 5 is a graph, and not a tree (i.e. it contains cycles).

The reader is advised that just like a set-cover solution in computational geometry, a minimum linked-guard-cover solution as taught above, is not a unique solution. The solution is not unique in the sense that more than one solutions may exist that offer the same near-optimal deployment of available sensing stations for providing coverage, while allowing the sensing stations to be in visibility region ν(p) of one or more other sensing stations. In other words, referring to our example and the solution offered in FIG. 5 there may be more than one set of placement sites from the set of candidate sites {p₁, p₂, . . . , pₘ} that cover the entirety of the interior of workspace 102 and also use 8 sensors of type 106, while keeping the sensors linked.

Further, also note that a solution derived by the variation of Greedy algorithm as taught by the instant invention, may produce a result that is not the most optimal solution, but rather a near-optimal solution, by up to a log factor. Consequently, it may be possible to have a most optimal solution for the above example comprise less sensing stations than the solution depicted in FIG. 5. Finally, also note that the Greedy algorithm by its nature is sensitive to the initial choice of a range during its programmatic iterations, and hence to the discretization or sampling of the workspace. It is therefore possible, that given a different initial choice of a range or a different discretization or sampling, the same Greedy algorithm may produce a better result i.e. use less number of sensors compared to the other choice of the initial range or sampling.

Let us now formalize the definition of a linked-guard-cover per above teachings. Let ν(r)⊂W be the sensing region of a sensing station at a site rεP, where P is the domain of all such sites in workspace W. For a set A of placement sites {s₁, s₂, . . . } of sensing stations with sensing regions ν(sᵢ), let ν(A) be the union of all sensing regions ν(sᵢ) in set A i.e. ν(A)=U_{iεA}ν(sᵢ). Set A is said to be ‘linked’ if for any subset B⊂A there exists some iεA\B such that ν(i)∩B≠. In other words, any subset of set A intersects with the visibility/sensing region of sensing station(s) at one or more placement sites in set A outside of that subset. Assuming the requirement is to cover the entire workspace W, the instant invention computes the smallest linked set S={s₁, s₂, . . . s_{d}} such that set ν(A)=W, or it computes a ‘best-effort’ solution when ν(A) cannot equal W. Note that P and W do not have to be the same, and advantageously, they may not even overlap. In other words, workspace W can observed by sensing stations outside of workspace W (by ‘looking in’).

In computational geometry, a sampling is an arrangement of points in the space chosen randomly, pseudo-randomly, along a regular grid, etc. Indeed through sampling a geometric problem is easily converted into a finite set system. Very often it is desired to discretely sample a workspace such that there are a finite number of discrete points that comprise candidate sites {p₁, p₂, . . . , pₘ} and ground set X. Note that using the norms of computational geometry we are referring to our set X of all target sites in workspace 102 from FIG. 4-6 as the ground set. Such a choice of terms will be apparent to those skilled in the art. Often, a discretized version of our workspace W above is the ground set X, and a discretized version of our domain P is the set of candidate sites {p₁, p₂, . . . , pₘ}. Then given the set family [symbol] of ranges as taught above, a linked-guard-cover is a constrained version of the set-cover problem of set system Σ={X, [symbol] } according to the teachings of the instant invention.

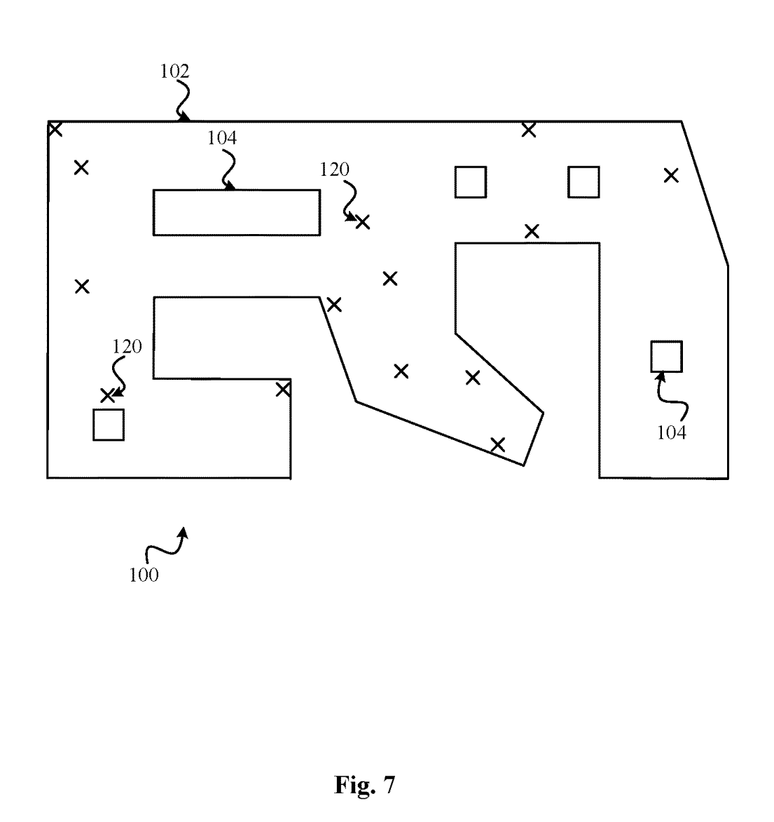

FIG. 7 represents workspace 102 that has been discretely sampled into a handful of points represented by ‘X’es in FIG. 5. Note also in FIG. 7 that for clarity we have only used reference numeral 120 to indicate two such sampled points or ‘X’es. Thus in the associated embodiment of the invention that utilizes a sampled workspace, it will be only required to observe points 120 marked by ‘X’es in workspace 102 as shown in FIG. 7, by the computed placement sites, rather than the entirety of the interior of workspace 102 (excluding obstructions).

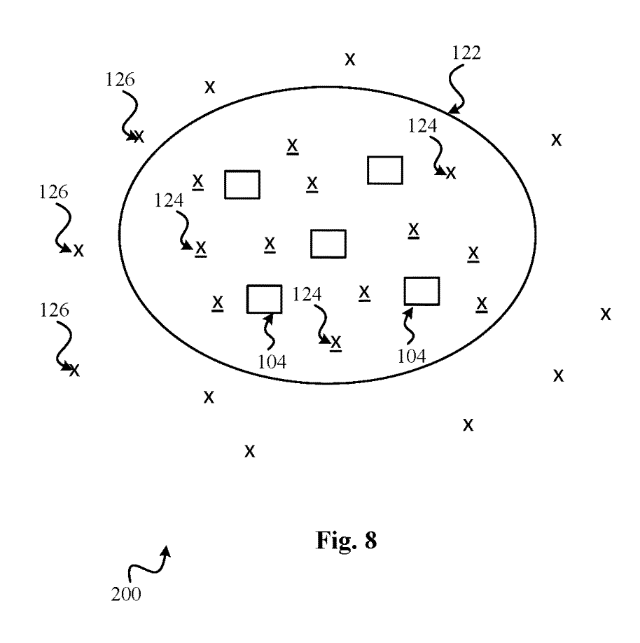

As stated above, that while in some embodiments, candidate sites {p₁, p₂, . . . , pₘ} and ground set X are overlapping, that is, a candidate site can also be target site or vice versa. However, in an alternative embodiment of the invention, candidate sites and target sites do not overlap. Such a situation is expected when there is a set of locations, such as walls or ceilings for sensing stations, and there are points or locations of interest on the floor or other parts of the building that are required to be observed. FIG. 8 represents such a scenario where oval shape 122 represents a region of interest 122 containing target sites 124 while candidate sites 126 exist outside of region of interest 122 and are non-overlapping with target sites 124. Note again, that for clarity we have labeled only three candidate sites by reference numeral 126 indicated by crosses ‘X’ (not underlined), and only three target sites by reference numeral 124 indicated by ‘X’ (underlined).

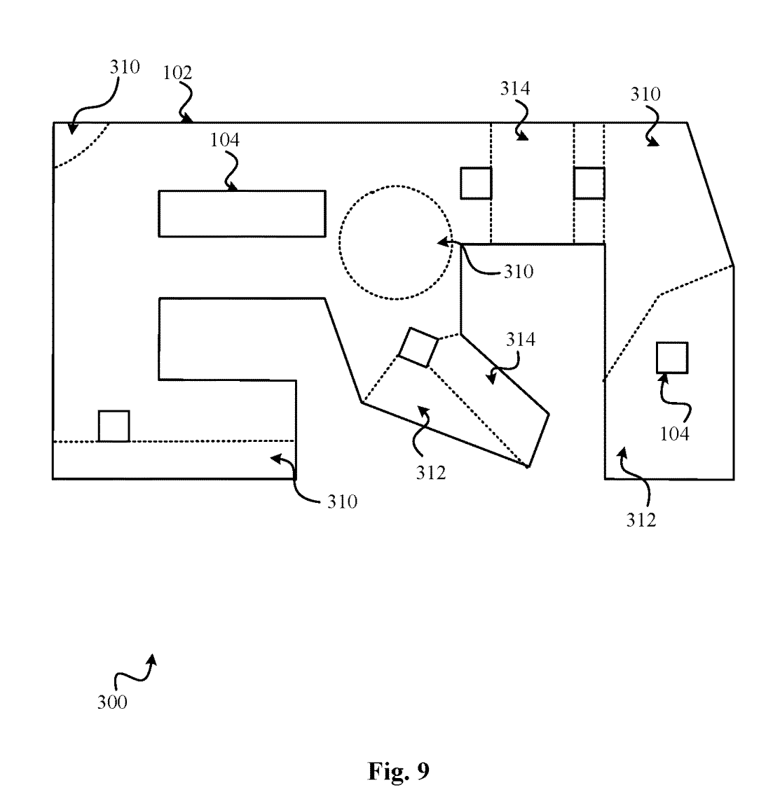

Now we will look at a variation of the embodiment explained earlier with the added constraint that placement sites for a certain type of sensor can only be chosen from a set of sampled points or a placement region and that only a certain quantity of certain types of sensors are available. Such constraints are commonplace in real environments where cameras and other sensors are available in limited quantity and they can only be placed at appropriate locations in a workspace, such as walls and ceilings of a certain height, shape, construction, etc. Such a scenario is represented in FIG. 9 where unconstrained omni-directional sensors 106 of FIG. 4 can only be deployed or placed in placement regions 310 indicated by dotted lines, directional but range-unconstrained sensor 108 of FIG. 4 can only be deployed or placed in placement regions 312 indicated by dotted lines, and directional and range-constrained sensor 110 of FIG. 4 can only be deployed or placed in placement regions 314 indicated by dotted lines shown. Let us further impose the constraint that five sensors of type 106 are available, two sensors of type 108 and two sensors of type 110 are available. Indeed the capability to incorporate such constraints as to where potential candidate sites can be located and how many sensors of a given type can be used, represents one of the highly preferred embodiments of the present invention.

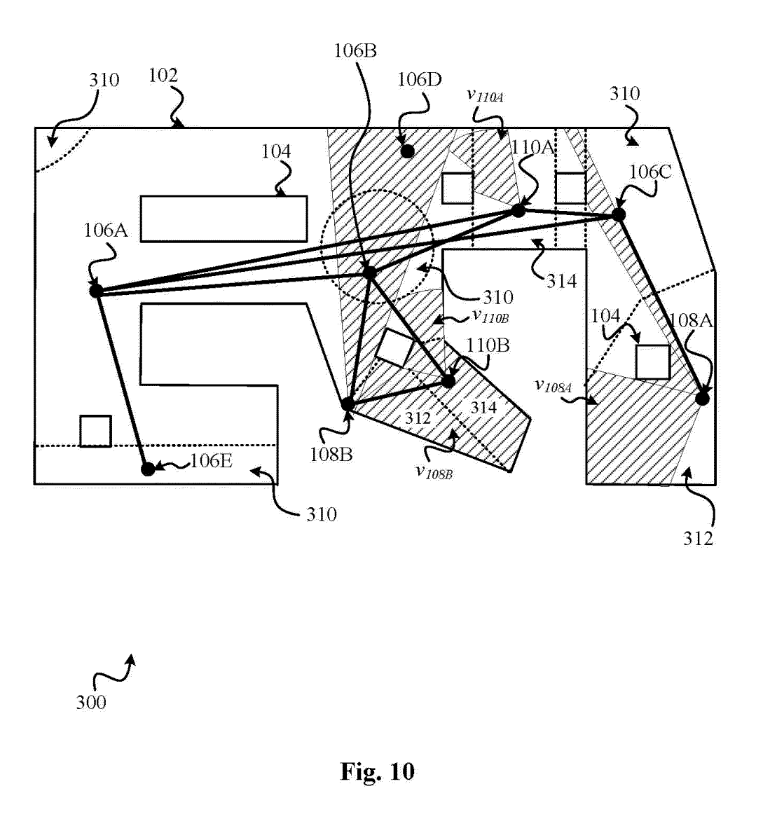

Based on a variation of the Greedy algorithm presented above, FIG. 10 represents a solution derived by the present invention. Note that the algorithm has determined the placement sites for the five available sensors of type 106 in placement regions 310 as required, it has determined the placement site for two available sensors of type 108 in placement regions 312 as required, and further the algorithm has placed the last two available sensors of type 110 that are both directional and range-constrained to cover the remainder uncovered regions in place regions 314 as indicated in FIG. 10. Note also that for clarity, we are explicitly showing the sensing regions of the 4 constrained sensors only i.e. two each of types 108 and 110, by hatches, as they cover various parts of workspace 102. The reader is invited to confirm that the computed solution illustrated in FIG. 10 indeed satisfies the constraints of the placement regions.

Now we will look at the changes or variations to the Greedy algorithm presented above, that are required to enable this embodiment having constraints on the placement and quantities of sensors. Note that in as far as the constraint requiring the placement of the sensing stations at predetermined locations or placement regions, this constraint is easily satisfied by the selection of candidate sites {p₁, p₂, . . . , pₘ} in the first place. In other words, we will only pick candidate sites that satisfy the placement constraints of the problem i.e. we will pick candidate sites within placement regions 310, 312, 314 (see FIG. 4, FIG. 9) for sensors 106, 108, 110 respectively.

As far as satisfying the constraint of predetermined quantities of various types of sensors, the Greedy algorithm above can be modified to include a ‘tally’ for each type of sensor. During each iteration of the algorithm shown, before choosing a range the algorithm will first check if the tally for the corresponding sensor is greater than zero. Once it picks the range with the largest cardinality, it will also decrement the tally of the corresponding sensor. If the tally reaches zero, the algorithm will stop choosing ranges corresponding to that sensor in subsequent iterations. Once all tallies have reached zero, the algorithm will terminate, whether or not a full cover has been computed. Note that this will be a best-effort solution by the Greedy algorithm presented earlier. Such a best-effort algorithm will not guarantee that the computed solution will cover the entire ground set X, and may only provide a partial cover while keeping the sensing stations linked. Indeed the solution illustrated in FIG. 10 shows an execution scenario, where the algorithm has computed a minimum linked-guard-cover of the instant invention, that offers a full cover while keeping the stations linked.

As taught above, preferably the minimum linked-guard-cover that forms the basis of the sensor deployment strategy of the present invention is based on the familiar Greedy algorithm. In the preferred embodiment, the minimum linked-guard-cover determined by the present invention is found in polynomial time. Those skilled in the art will know that Greedy algorithm gives an approximation ratio that is bounded by (1+log R_{L}), where approximation ratio is defined as the size of the computed cover C divided by size of the optimal cover C* i.e. |C|/|C*|, and Rₗ is the range set with the largest cardinality in set family [symbol] . The Greedy algorithm is effective for applications where the size of set R_{L} i.e. |R_{L}| is a small fraction of the size of ground set X i.e. |X|.

Let us now formally derive the computation time/cost of the modified Greedy algorithm of the present invention whose implementation-level pseudo-code was presented above, and convince ourselves that it is indeed a polynomial-time algorithm. We will do so by analyzing the computation time of each computationally intensive step of the algorithm. The computation time of step 4. will be [symbol] (md log n), where d=|S| is the cardinality of the final, computed linked-guard-cover, n is the number of edges in the workspace (also sometimes referred to as the complexity of the workspace), and m is the number of candidates sites {p₁, p₂, . . . , pₘ} in the initial set P. This is because each of steps 4.1 and 4.2 requires [symbol] (log n) visibility checks, and asymptotically there are [symbol] (md) such visibility checks.

Further, this computation cost of step 4. is less than the cost of step 1.3, which is [symbol] (m|X|log n) in the worst case. Though typically, d<<|X| i.e. the number of target sites usually far exceeds the number of computed guards. Finally, the cost of step 3. remains the same as in the conventional Greedy algorithm i.e. [symbol] (|R₁|+|R₂|+|R₃| . . . ). One with average skill in the art will conclude from the above proof, that the time complexity of our modified/customized Greedy algorithm presented above remains polynomial and in fact comparable to the conventional Greedy algorithm.

An alternative algorithm for finding a set-cover was proposed by Bronnimann and Goodrich in “Almost optimal set covers in finite VC-dimension” (1995). Based on this approach, given our set system Σ={X, [symbol] } above having a VC-dimension of d and using the familiar Big-O notation, there also may be a polynomial-time algorithm for finding a linked-guard-cover with size at most a factor [symbol] (d log dC*) from the optimal size C. Note that this bound does not explicitly depend on the cardinality of set X or the largest set in [symbol] . Preferably, the solution used to determine the minimum linked-guard-cover as taught by the present invention is of size at most a factor [symbol] (d log dC*) from the optimal size C. Still preferably, the VC-dimension d above is bounded by [symbol] (log h) where h represents the number of obstructions, such as those represented by reference numeral 104 in FIG. 4-10. Those skilled in the art will recognize that there can be any number of algorithms including the ones described above that may be employed to solve for the minimum linked-guard-cover as the basis for the sensor deployment strategy provided by the present invention.

Recall from earlier teachings that the instant invention allows a given sensing station to have multiple sensors on it, each with its own sensing region as defined above. Specifically recall that there are k sensing regions νₖ(p) around a sensing station located at a candidate site p and that there is a composite sensing region ν(p) of the sensing station as a collection of all k sensing regions νₖ(p) when the sensing station is at candidate site p in the workspace. Such a collection of individual sensing regions νₖ(p) can preferably be a union of the individual sensing regions νₖ(p) to form the resultant composite sensing region ν(p) i.e. ν(p)=∪_{ν}_{ₖ}₍ₚ₎. This scenario is readily conceivable in an application where a sensing station may have multiple types of receivers and the objective is to determine a heartbeat of a sensed station or a target site without caring which sensor it comes from. For example if the sensed station is a short-range radio device that emits radio frequencies, and the objective of the application is to ensure that the device is present, then the sensing station equipped with a camera and a radio receiver may be employed. As long as there is a visual confirmation from the camera on the sensing station or the reception of the short-range radio signal, the objective of determining the presence or the absence of the radio device is achieved.

In an alternative embodiment, the above collection of individual sensing regions νₖ(p) can preferably be an intersection of the individual sensing regions νₖ(p) to form the resultant composite sensing region ν(p) i.e. ν(p)=∩_{ν}_{ₖ}₍ₚ₎. Again, such a scenario is easily conceivable in an application where a positive confirmation from multiple sensors has to be obtained for the objectives of the application. Using our example above, if the requirements to ascertain the presence or absence of the short-range radio device in question are such that not only the short-range radio signal has to be received, but also a visual confirmation of the blinking lights on the radio device in sync with the reception of the radio signal is also required, then the intersection operation of the individual sensing regions will be the right approach to form composite sensing region ν(p).

Indeed in yet another preferred embodiment, the invention allows for a generic set operation to be performed on the individual sensing regions to form the resultant composite sensing region as may be required for a given application. Continuing our example above, if a third sensor on the sensing station is a microphone, then a positive confirmation of the presence of the short-range radio device may be obtained by the following definition of the composite visibility region of the sensing station: ν(p)=((ν_{radio}∪ν_{audio})∩ν_{νisual})(p) i.e. either a radio or audio signal would suffice, as long as it is obtained with a visual confirmation. To conclude this discussion, and as previously mentioned, it is entirely conceivable within the scope of the instant invention to have a single complex sensor on a sensing station that has multiple sensing regions νₖ(p), for example, an Audio-Visual camera equipped with a lens and a microphone.

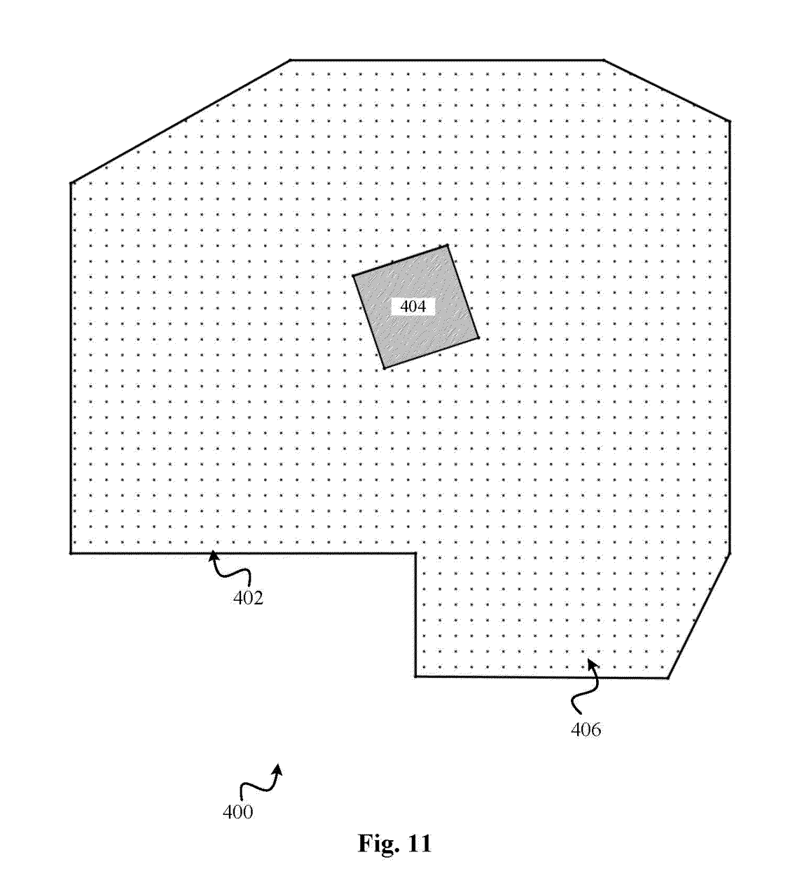

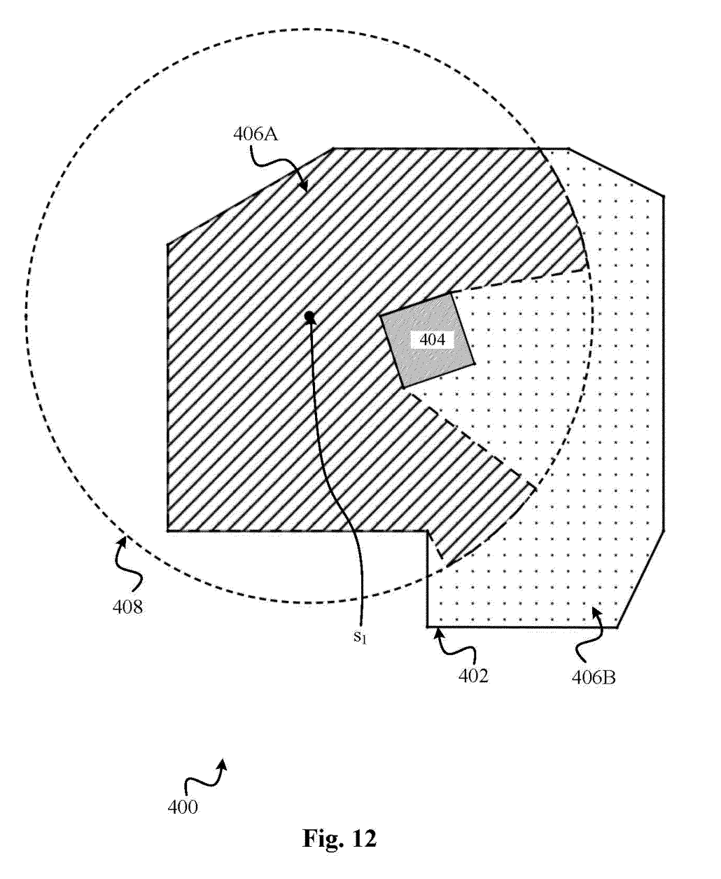

Let us look at another advantageous aspect of the instant invention, illustrated in FIG. 11. FIG. 11 shows a sensor deployment system 400 according to the instant invention, having a workspace 402 that contains a large number of target sites or points to be observed 406, indicated by dots in workspace 402. This can be as a result of a dense discretization or sampling of workspace 402, as taught earlier. Workspace 402 further contains an obstruction 404. Now let us find a linked-guard-cover for target sites 406 of the embodiment shown in FIG. 11, according to the instant invention. Let us first place a sensing station s₁ or guard on the left or west side of obstruction 404. Let us assume that guard s₁ is omni-directional and has a range constraint. In other words, sensor s₁ has a practical range that is less than the dimensions of workspace 402. FIG. 12 shows such a placement of sensor s₁ in the embodiment of FIG. 11 with its visibility or sensing region 408 shown by the dashed circle. Note that for clarity, we have chosen to hatch the sensing region of sensor s₁ that is internal to workspace 402 only.

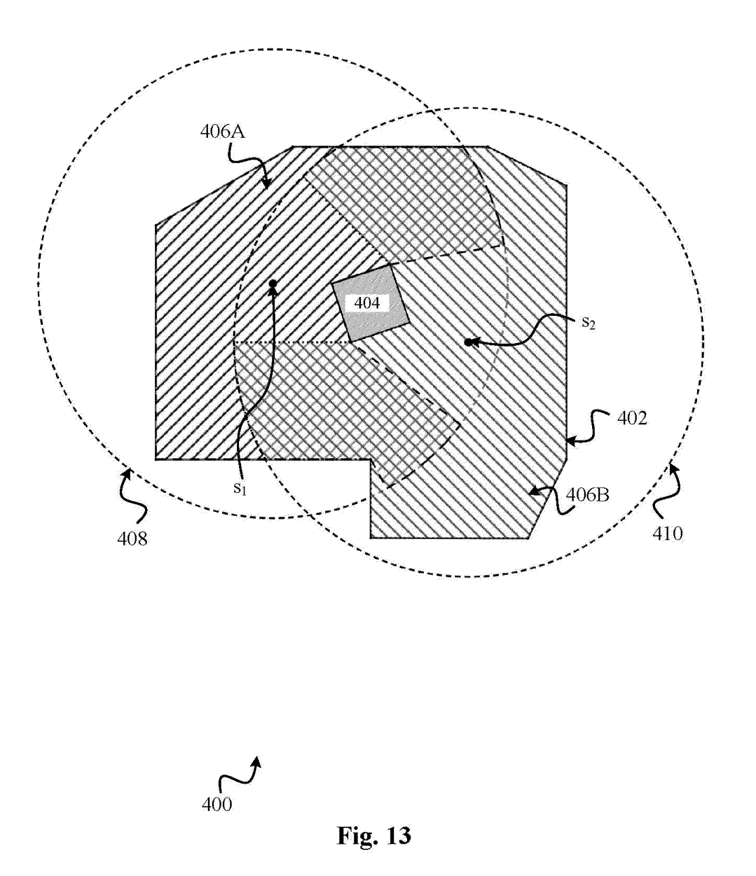

In FIG. 12, notice the target sites 406A that are covered by sensor s₁ and target sites 406B that are still not covered because of obstacle 404 and the constrained range of sensor s₁. Now let us add another guard to remedy that situation. FIG. 13 shows such a placement of another sensing station/guard s₂ on the opposite side of obstacle 404. Guards s₁ and s₂ now indeed cover all target sites 406 in workspace 402. Notice that targets 406A as well as 406B are covered by sensors or guards or sensing stations s₁ and s₂, as represented by the dashed circles of their visibility or sensing regions 408 and 410 respectively. Note that for clarity, we have chosen again to only hatch the visibility or sensing regions of sensors s₁ and s₂ that are internal to workspace 402.

While sensing stations s₁ and s₂ form a minimum set-cover for workspace 404, they do not form a linked-guard-cover. In other words, guard s₁ is not in the sensing region of guard s₂ and vice versa. Explained further, guards s₁ and s₂ cannot sense/communicate with each other, unless some external mode of communication is provided between them. A practical example of this scenario could occur at the site of a building, where coverage by two difference sensors, e.g. wifi-routers is provided on two different sides of the buildings. However, the two wifi-routers are outside of the range of each other, or cannot see/communicate with each other due to building obstructions. In such a scenario, an extra cabling may need to be provided between the two routers, so that they can communicate and potentially collaborate according to the requirements of the application.

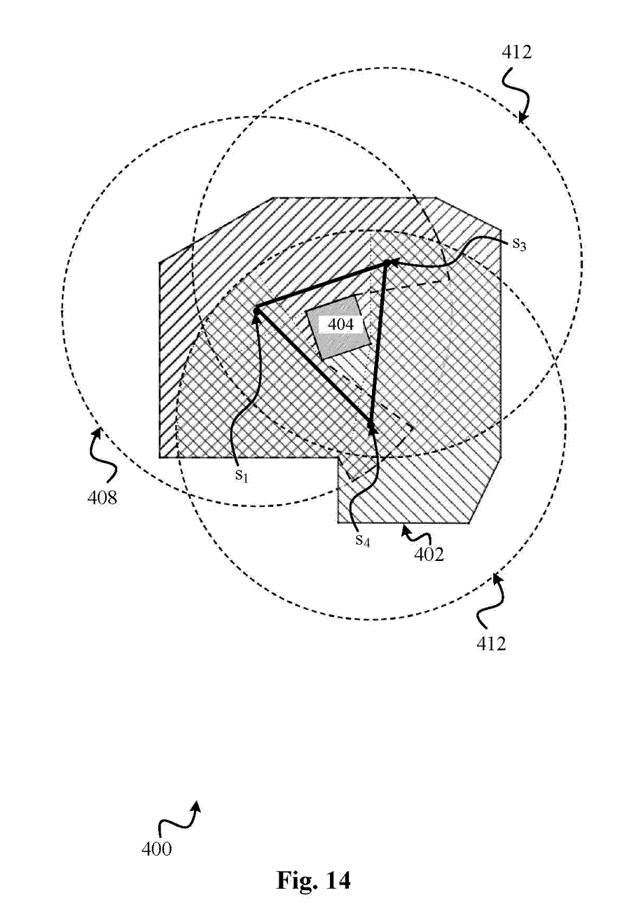

Now let us compute a linked-guard-cover for the embodiments of FIG. 12-13 according to the present invention. FIG. 14 shows such a linked-guard-cover as computed by the modified Greedy algorithm presented above of the instant invention. FIG. 14, shows sensing stations s₁, s₃ and s₄ that form a linked-guard-cover computed by the instant invention. Notice that unlike the minimum set-cover of FIG. 13, there is no sensing station s₂ in FIG. 14. Instead, sensors s₃ and s₄ have been placed in such a manner, that together sensors s₁, s₃ and s₄ provide coverage for the entirety of workspace 402 as well as stay within the sensing region(s) of each other. Notice that stations/nodes s₁, s₃ and s₄ of linked-guard-cover of FIG. 14 form a complete graph as shown by the line segments connecting them, however that is a coincidence and not a guarantee. In other words, the linked-guard-cover computed by the instant invention is guaranteed to form a connected graph, but not necessarily a complete graph. The concepts of a graph, connected graph, complete graph, fully connected graph, tree, spanning tree and minimum spanning tree (MST) as used in this specification are commonly understood in graph theory by people of average skills, and hence not introduced in detail in this specification as not to detract from the innovative aspects of the invention.

Furthermore, the present invention computes linked-guard-cover using a modified Greedy algorithm which is near-optimal but not always guaranteed to be optimal as will be recognized by skilled artisans. Explained further, the modified Greedy algorithm of the present invention does not guarantee that the linked-guard-cover it finds will always be the minimum linked-guard-cover. While in many cases it may be a minimum linked-guard-cover, the present invention only guarantees that it will find such a minimum linked-guard-cover on a best-effort basis. In practice, the Greedy algorithm and its variations are well-liked because of their efficiency of a polynomial time complexity while still usually producing the optimal, and almost always the near-optimal result, over a fully exhaustive exponential time algorithm that would always guarantee to find the optimal result, but may be cost-prohibitive to implement.

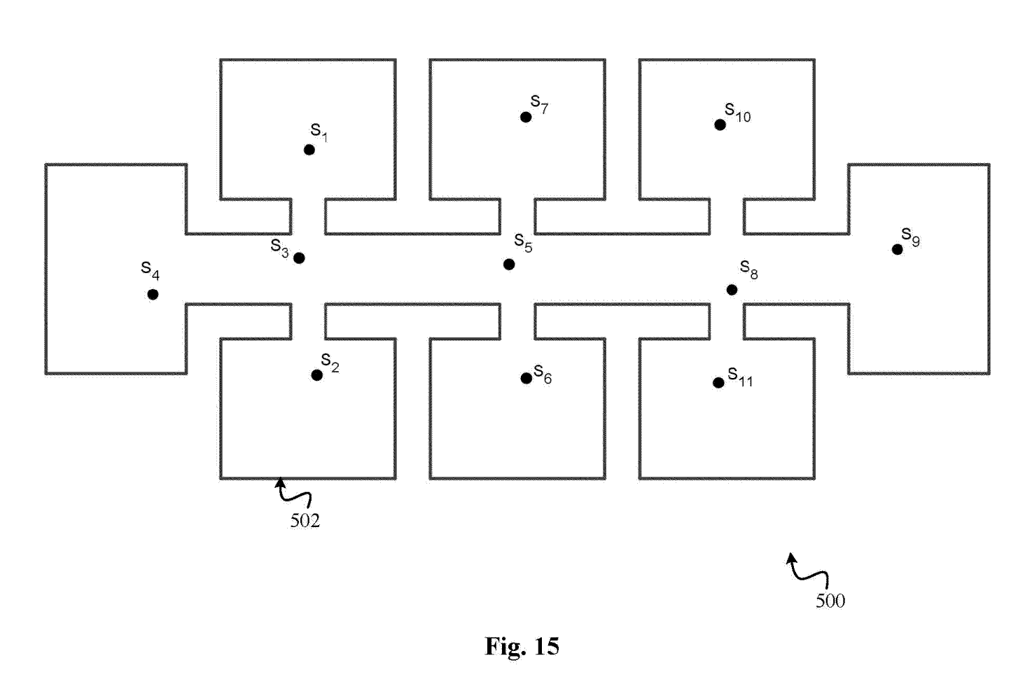

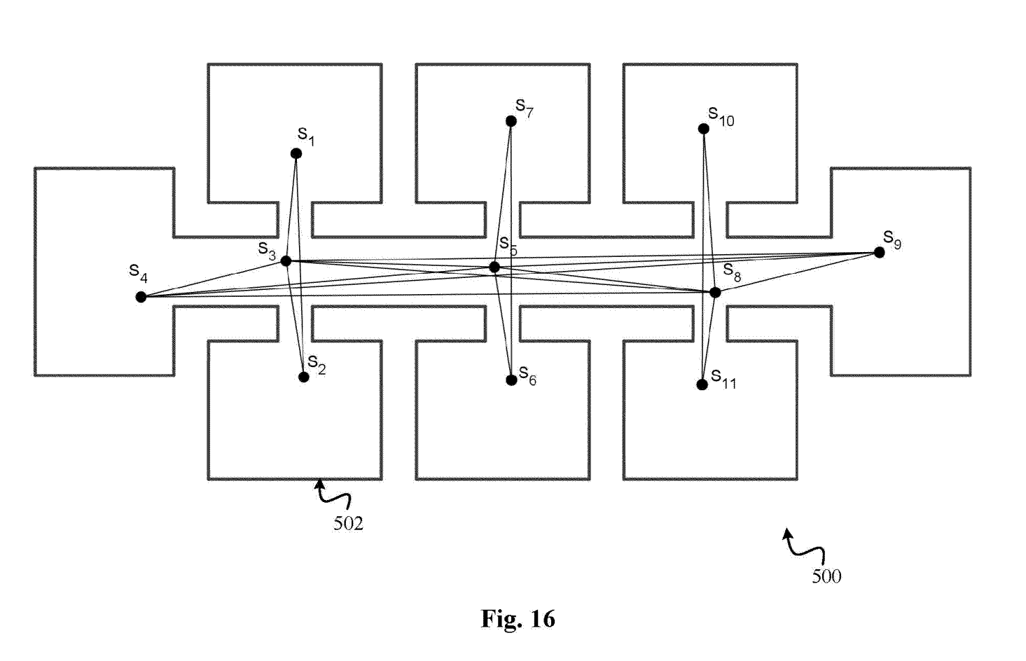

FIG. 15 shows another embodiment of sensor deployment system 500 of instant invention showing several sensing stations s₁-s₁₁ of a linked-guard-cover computed by the instant invention, for workspace 502. Note that sensors/sensing stations s₁, s₂, . . . , s₁₁ cover the entirety of workspace 502 while ensuring that every sensor S₁, s₂, . . . , s₁₁ is reachable by any other sensor s₁, s₂, . . . , s₁₁. FIG. 16 explicitly shows the connected graph whose nodes are sensors s₁, s₂, . . . , s₁₁. Representing the linked-guard-cover as set S={s₁, s₂, . . . s₁₁}, we can build a graph [symbol] (S,E) where E is a binary matrix such that E_{i,j}=1 if sᵢεν(sⱼ) and sⱼεν(sᵢ) according to above teachings of visibility region ν(p), and E_{i,j}=0 otherwise. In other words, an edge between a node/sensor sᵢ and a node/sensor sⱼ in graph [symbol] (S,E) signifying that sensor sᵢ can see/observe/sense/communicate with sensor sⱼ and vice versa, is represented by corresponding entry E_{i,j} of matrix E as 1, and 0 otherwise. Such a binary matrix representation of graphs is common in the art as will be recognized by the skilled readers. Graph [symbol] (S,E) for sensors S₁, s₂, . . . , s₁₁ of FIG. 15, is shown in FIG. 16.

Graph [symbol] (S,E) can be computed in [symbol] (d² log n) time, where d=|S|, and n is the number of edges in the workspace. Hence, a workspace having a constant complexity (n=k), computation cost of graph [symbol] (S,E) is [symbol] (d²), or quadratic with the size of the computed placement of sensing stations/guards. Differently stated, for problems with a fixed/constant placement size (d=k), the cost is [symbol] (log n), or logarithmic with the workspace complexity. Specifically for the example illustrated in FIG. 15, |S|=11, and n=60, so the computation time for graph [symbol] (S,E) of FIG. 16 will be [symbol] (11² log 60)≈ [symbol] (215) in units of computation time of [symbol] (1).

Those skilled in the art will understand the Big-O notation and the steps required to compute the complexity of an algorithm based on the computation time of an [symbol] (1) operation for the data structures involved and for a given computing environment, such as processor speed, the number of bits in the processor, amount of Random Access Memory (RAM), etc. Further, linked-guard-cover S={s₁,s₂, . . . s₁₁} of the instant invention can be computed using data structures where graph [symbol] (S,E) may be computed in parallel to the determination of linked-guard-cover S={s₁,s₂, . . . s₁₁}, thereby significantly reducing the computation time of graph [symbol] (S,E) of FIG. 16 from its bounded value of [symbol] (d² log n) above.

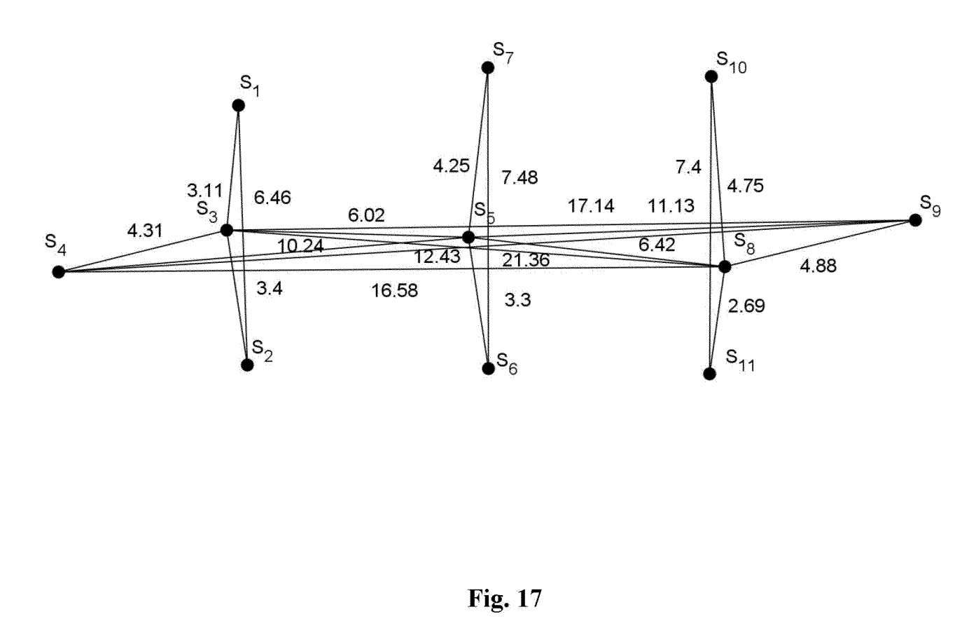

The algorithm of the present invention guarantees that graph [symbol] (S,E) will be a connected graph. Preferably, the invention computes a tree of graph [symbol] (S,E) using any technique known in the art. A tree is a connected graph without simple cycles, as will be understood by skilled artisans. We can further weight the edges of graph [symbol] (S,E) by the distance between stations or any other suitable metric of choice. For example, we can also weight the graph edges by the strength of the signal between the respective nodes or stations, the type of the signal, the size of message required to be communicated between the respective edges, etc. One such weighting of graph [symbol] (S,E) using the distance between respective nodes or sensing stations is shown in FIG. 17. From the weighted graph shown in FIG. 17, the invention preferably computes a minimum spanning tree (MST) of the weighted graph. As will be recognized by skilled readers, an MST is a spanning tree that connects all nodes/stations with a total weight less than or equal to any other spanning tree of the graph.

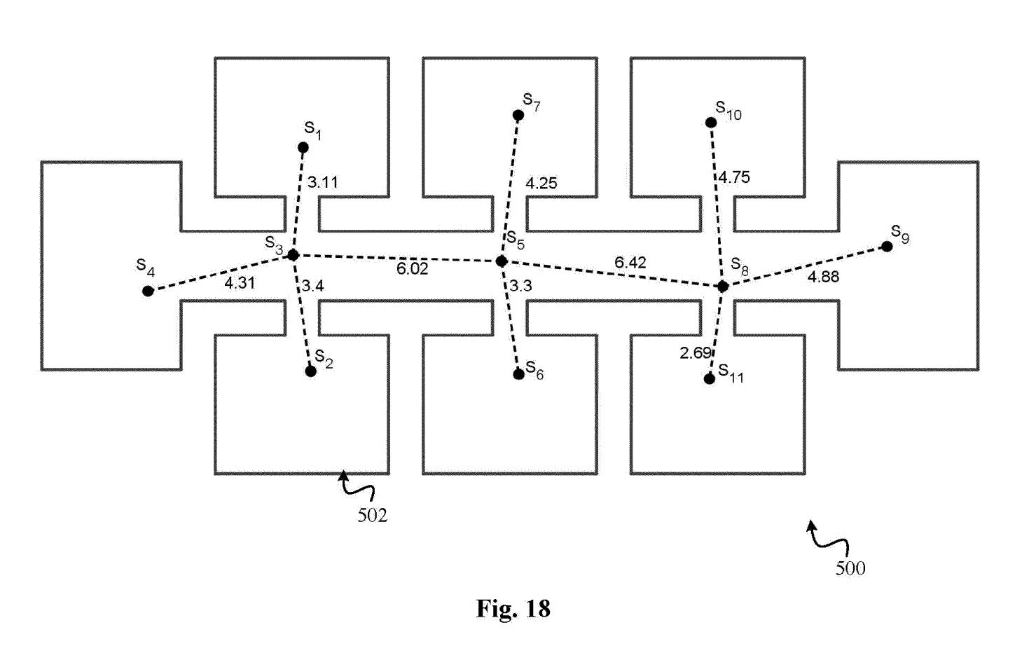

FIG. 18 shows an MST of the weighted graph of FIG. 17, along with workspace 502 of FIGS. 15-16. An MST can be computed from a weighted graph by one of the several popular algorithms, such as Prim's algorithm. These techniques are understood in the art and will not be delved into detail in this specification. As already stated, linked-guard-cover S={s₁,s₂, . . . s₁₁} computed by the instant invention is preferably used to compute an MST or alternately a tree, of the graph of the placement sites/nodes s₁,s₂, . . . s₁₁ of its sensing stations/nodes, using any known technique in the art. An MST is useful for a number of reasons. First, the root node of the MST, such as the one shown in FIG. 18, can be the gateway node for connectivity of system 500 to an external environment. That is because the root of an MST offers itself as the natural ‘starting location’ of the MST from where all other nodes/stations can be reached. Similarly, the root of a tree can also offer itself as an optimal point of connectivity to an external environment. An external environment can be any other system not otherwise directly connected to the systems shown in FIGS. 15-16 and FIG. 18.

In a highly preferred embodiment of the present invention, target sites are not merely locations or points, but sensed stations or smart sensors, with their own sensed regions analogous to sensing regions of sensing stations taught above.

This unique capability of the present invention, allows the sensor deployment based on minimum linked-guard-cover as taught above to be applied to a variety of interesting applications in a number of industry verticals that have requirements to observe and detect not just passive parts of a geography or ‘locations’ of interest, but rather monitor active devices with their own smart transmission capabilities and their own unique configurations, characteristics and radiation patterns.

Thus, each sensed station also has one or more sensed regions around it, likely but not necessarily, as a result of the individual sensors present on the sensed station. A sensed region of a sensed station at a target site is defined as the set of all sites around that sensed station that if overlapping with the sensing region of a sensing station at a candidate site will result in that sensed station being sensed or communicated with, by that sensing station. Preferably, the sensing region of a sensing station at a candidate site and a sensed region of a sensed station at a target site are defined such that the sensing station can sense or communicate with the sensed station only if the sensed station is in the sensing region of the sensing station and the sensing station is in the sensed region of the sensed station.

Preferably, the sensed region is further constrained by a sensed range and a sensed orientation of the sensed station. Preferably, there is a composite sensed region around each sensed station that is a collection of the individual sensed regions around the sensed station. Preferably, each range in the set of ranges above is further chosen such that the candidate site corresponding to the range lies in the sensed region of the sensed stations placed at the target sites of that range.

In a related embodiment, the collection of individual sensed regions of a sensed station, called the composite sensed region, is taken to be a union of the individual sensed regions. Alternatively, the composite sensed region is taken to be an intersection of the individual sensed regions. Still in another embodiment, the composite sensed region is taken to be based on a generic set operation of the individual sensed regions of the sensed station.

Another preferred embodiment requires that the set of placement sites to be computed are such that each sensed station is able to be sensed by at least two sensing stations. This capability enables the invention to perform triangulation to determine the location of a sensor or sensed station. If each sensing station is covered by three sensing stations, then another technique called trilateration can be performed to determine the location of a sensor or sensed station. We refer to the capabilities of performing triangulation or trilateration as ‘localizability coverage’ of the present invention.

Those skilled in the art will understand the basic mechanism of triangulation for determining the location of a point by measuring angles to it from known points at the two ends of another fixed baseline. The point can then be fixed as the third point of a triangle with one known side and two known angles ∝ and β. The accuracy of triangulation is heavily dependent on the lesser of these two known angles, which we assume is ∝ in the present discussion. It is therefore of great interest to compute ‘two-guarded’ covers that guarantees ∝>∝′ for all target sites, where ∝′ is a performance threshold. In “Approximation Algorithms for Two Optimal Location Problems in Sensor Networks”, Efrat et al. of University of Arizona, Tucson (2005) proves that if a ‘two-guarded’ cover with angle threshold ∝′ exists, and given a set-cover G₁ computed to provide standard ‘single-guard’ coverage, then any target site in set X of target sites can be ‘two-guarded’ or sensed by two sensing stations by choosing one placement site from G₁ and the second placement site from a second computed set-cover G₂. The second set-cover G₂ is guaranteed to exist and its computation can be decoupled from the computation of the first set cover G. The result is a ‘two-guarded’ coverage albeit with a performance threshold α′/2.

Such an approach can be easily implemented using the current invention by computing a set of placement sites or the first linked-guard-cover as in the main embodiment, and then performing a second pass by first removing the original set of placement sites from the available candidate sites {p₁, p₂, . . . , pₘ} and computing a second linked-guard-cover or set of placement sites to obtain the ‘two-guard-linked-cover’ solution. Such a two-guard solution will provide at least two placement sites that can sense each sensed station, and hence can be used to triangulate the position of any sensed station in the workspace (provided the observation angle is satisfactory for the requirements). Similarly, within the scope of the invention and using above techniques, one can compute a ‘three-guard’ solution of the target sites in set X to be able to trilaterate the position of any sensed station. Those skilled in the art will be familiar with the mechanism of trilateration using three known positions and will know that good trilateration is achieved when each sensed station is contained inside some triangle formed by three sensing stations. Of course, the above embodiments have the essential characteristic of the instant invention, that the guards themselves can see/observe/communicate with, any subset/grouping of each other.

Recall the earlier definition of a sensing region νₖ(p) around a sensing station at a candidate site p as the region in which the sensing station can sense a sensed station. We will refer to such coverage as ‘sensing coverage’. A highly preferred set of embodiments of the invention expand the above capabilities of sensing coverage to include the ability to communicate and not just sense. Consequently we will refer to such coverage as ‘network coverage’. Obviously network coverage implies sensing coverage. In other words, communication implies sensing. Differently put, the act of communicating with another device such as a sensed station, indicates the knowledge of the presence or sensing, of that device or sensed station. Obviously, if the device or sensed station is not present, then a sensing station can still sense the site or location where the sensed station could have been, but not able to communicate or provide network coverage to that site.

Communication can take a number of different forms including but not limited to sending and receiving messages that may contain just ‘pings’ or data payload, sending and receiving different types of electromagnetic radiation patterns to mean different things, sending and receiving different types or strengths of electrical signals to mean different things, sending and receiving different types or strengths of audio signals to encode different meanings and varying any characteristic of a physical signal to encode messages, etc.

Let us address the expanded definition of a sensing region of the current invention under network coverage more precisely. To enable network coverage, sensing region of a sensing station at a given candidate site represents the collection of sites or locations in the workspace where the placement of a sensed station will enable the sensing station to communicate with that sensed station. More rigorously, a sensing region νₖ(p) around a sensing station located at a candidate site p represents the collection of target sites b where target site bενₖ(p) if the placement of a sensed station at site b will allow the sensing station to be able to communicate with the sensed station despite the obstructions in the workspace. Further, a composite sensing region ν(p) of the sensing station is a collection of all such k sensing regions νₖ(p) when the sensing station is at candidate site p in the workspace. Further still, such a collection can be a union of all such k sensing regions νₖ(p) i.e. ∪_{ν}_{ₖ}₍ₚ₎, an intersection i.e. ∩_{ν}_{ₖ}₍ₚ₎, or it can be based on a generic set operation on sensing regions νₖ(p).

In the preferred embodiment of the invention the sensing stations and the sensed stations of the present invention are wireless devices that operate substantially in the 60 GHz range. Those skilled in the art will agree that 60 GHz frequency range is poised to become the next big frequency in the world of wireless devices, with both short-range and wider area applications. The frequency is part of the ‘V-Band’ frequencies in the United States and is considered among the millimeter radio wave (mmWave) bands. Its applications will include a broad range of new products and services, including high-speed, point-to-point wireless local area networks and broadband internet access. High Definition Wireless (WirelessHD) is another recent technology that operates substantially near the 60 GHz range. A key characteristic of this frequency range is that its highly directional, ‘pencil-beam’ signal characteristics permits different systems to operate close to one another without causing interference. The upcoming Wi-Fi standard IEEE 802.11ad is also slated to run in this frequency range.

In another preferred embodiment of the instant invention, the workspace is a video, whether realtime or near-realtime streaming video or pre-recorded footage. In this interesting embodiment the applications include finding a scene in the video that would cover a desired place, such as a geographical location in an urban or sub-urban environment, a building, or a specific room in the building. Examples of such an application are in video editing where the director and video editor are interested in ensuring that a certain part of the set, such as a house or the living room of the house, is adequately covered in the final edited footage that was originally taken by a number of different cameras from different locations.

Alternatively, a criminal investigation may be concerned with ensuring that a certain event that had transpired is as fully covered by the available footage from passerbys and security cameras on the surrounding building as possible. The present invention provides such a capability by mapping the sensing stations to be the cameras with their associated timelines, set of target sites X to be the set of objects or points of interest in the footage, or events or the scenes that need to be covered. By computing a linked-guard-cover, instead of a simple cover, the instant invention further provides the capability that any camera is within the sight of some subset of other cameras at all times. The linked-guard-cover can ensure that every camera was indeed located where it says it was, thereby validating if the whole placement of the cameras is legitimate or suspect. This is valuable information for video forensics.

In a similar embodiment of the present invention, the sensing stations are persons, sensed stations are other persons, the region of interest or workspace is a geographical area, while the candidate and target sites comprise the location coordinates in the geographical area. A possible use-case is of course the monitoring or surveillance of regions of interest in that geographical area by having target sites located in those surveillance regions or regions of interest. In a related embodiment, the sensing stations or sensed stations are other objects of interest, and not necessarily human beings. Of course, many applications fitting such embodiments are easily conceived. An example use-case for such an embodiment is ensuring that celebrities (sensed stations) at the Academy Awards ceremony or The Oscars at Dolby Theater in Hollywood (workspace) are adequately covered by NBC videographers (sensing stations). Another example could be vehicles in a parking lot or a transportation hub that need to be tracked by sensors, etc. Of course, the instant invention provides for the above embodiments all the while ensuring that any sensor/camera is within the site of at least on other sensor/camera.

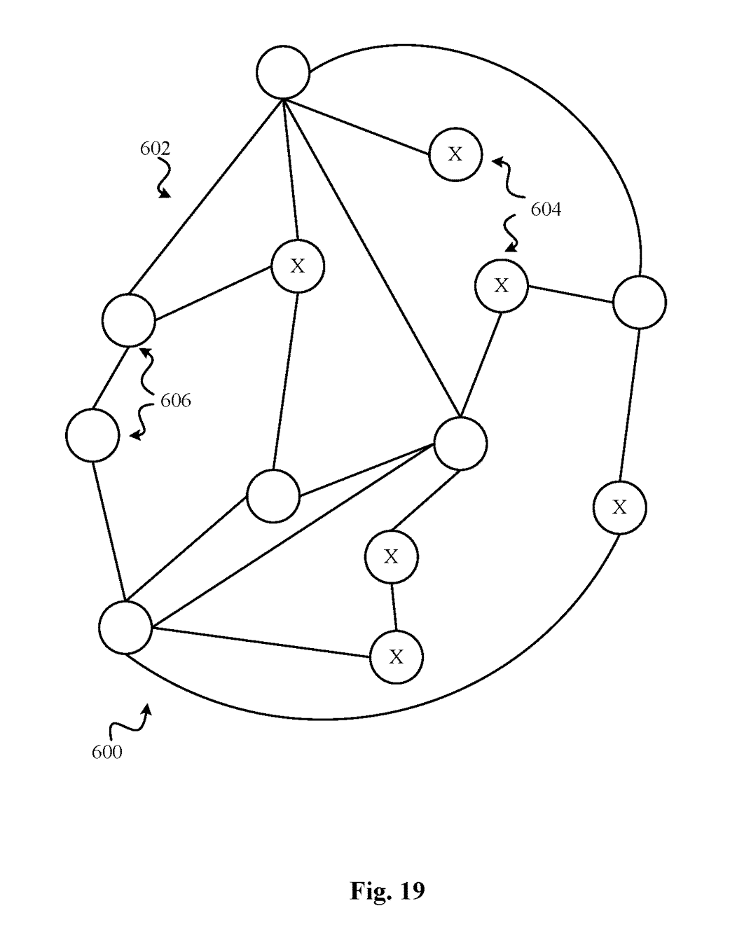

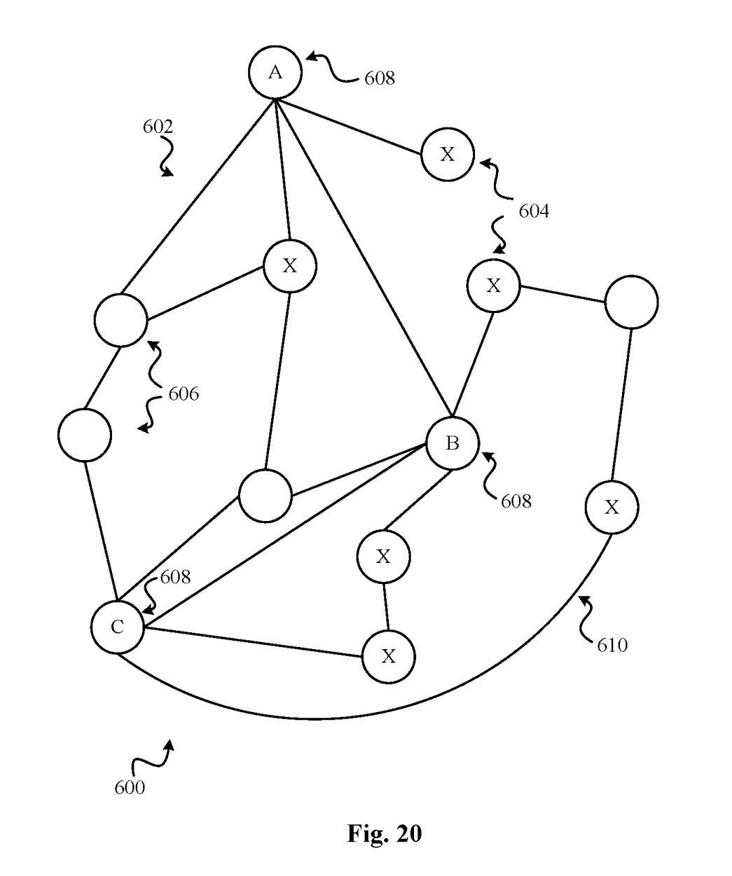

In yet another set of highly preferred embodiments of the present invention, a social graph is treated as the workspace. With the ubiquitous presence of social networking communities such as Facebook, LinkedIn, Google+, MySpace, Instagram, Tumblr, YouTube the notion of a social graph is ever more important, at a personal level for the user, at a commercial level for marketers of products and services, and even for law enforcement agencies. To explain these embodiments, let us look at sensor deployment system 600 illustrated in FIG. 19 and FIG. 20.

FIG. 19 depicts social graph 602, for example, from one of the popular social networking sites mentioned above. The objective of the application is to ‘reach out’ to persons 602 in social graph marked with circles containing an ‘X’ in FIG. 19, in a coordinated fashion. By ‘coordinated’ fashion means, ensuring that the persons or anchors from whom the outreach campaign is going to run, are also connected, so that they can collaborate. An example use-case for such a requirement could be an election campaign or some other social community outreach campaign. In the present embodiment of the instant invention, persons 604 marked with ‘X’ comprise the ground set X, and their target sites comprise their locations in social graph 602 i.e. circles 604 marked with ‘X’ in FIG. 19. Linked anchors make distribution of information and materials more robust and effective. In another example, assume a marketer targets anchors with emails describing a new product. Often emails are ignored or discarded and do not convert. But if the anchors are linked then the other anchors can receive news about the new product from those anchors that indeed acted on the email.

Sensing stations are all other persons in the social graph shown by blank circles 606 in FIG. 19. As in the case of target sites above, the candidate sites are the correspondent locations of sensing stations in social graph 602 shown by blank circles 606 in FIG. 19. Note, that for clarity, we are using reference numerals 604 and 606 to indicate only two such target sites and candidates sites respectively, with the observation that more such target and candidate sites are present in social graph 602.

Using the present embodiment of the instant invention to achieve the application objective, the computed solution is presented in FIG. 20. FIG. 20 illustrates that the individuals marked with circles 608 containing A, B, C represent the placement sites where sensing stations need to be deployed. In other words, ‘popular’ persons with respect to target nodes 604 marked with an ‘X’, are nodes 608 marked with ‘A’, ‘B’, ‘C’ in social graph 602 as shown in FIG. 20. Nodes 608, marked with ‘A’, ‘B’, and ‘C’ provide the minimum linked-guard-cover or the subset of social graph 602 that is able to reach with the fewest number of placement sites or nodes, all target sites or nodes in social graph 602, while staying connected amongst themselves. In other words, notice that nodes 608, marked with ‘A’, ‘B’, and ‘C’ are themselves linked.

The significance of such a capability is profound from a marketing and outreach perspective. One can easily conceive of marketing and outreach campaigns that are designed to reach certain demographics or subsets of the social graph of a community. An exemplary situation will be an election candidate reaching out to a certain subset of the population. Note that in an alternative but similar embodiment, the ground set X may not comprise people, but rather products. For example, in marketing analysis a marketer is interested in knowing what customers are using what products. In such a situation an alternative graph comprising people and the products they are using may be constructed and used as the workspace for the present embodiment, to achieve the desired analytical objectives. One can also easily extend the notions of sensing and network coverages taught above to the present embodiments using a social graph. While a sensing coverage in a social graph implies the knowledge or the existence of person within the sensing as per above definitions, a network coverage would allow communication between popular persons and their friends, and their friends and so on.

Methods of the present invention further delineate the steps required to execute the sensor deployment strategy of the present invention taught above. The methods provide the steps for determining the placement sites from a set of candidate sites {p₁, p₂, . . . , pₘ} for sensing stations in a workspace, by first providing sensed stations that can be placed at target sites in the workspace, and representing all such target sites by set X. They further provide zero or more obstructions, and then provide one or more sensing regions νₖ(p) around each sensing station when the sensing station is at a candidate site p. Sensing region νₖ(p) is a collection of all sites b such that the sensing station at candidate site p is able to sense the sensed station at site b, despite the provided obstructions.

In related embodiments, the invention further extends the definition of sensing region νₖ(p) beyond sensing coverage to include communication and hence provide network coverage. Consequently in such embodiments, sensing region νₖ(p) is defined as a collection of all sites b in the workspace such that the sensing station at candidate site p is able to communicate with the sensed station at site b, despite the provided obstructions.

The methods further provide a sensing range and a sensing orientation to constrain the sensing region νₖ(p) of each sensing station, and then provide a composite sensing region ν(p) of a sensing station to be the collection of the individual k sensing regions νₖ(p) when the sensing station is at candidate site p. Furthermore, set family [symbol] ={R₁, R₂, . . . , Rₘ} whose union is the target set X is created, such that a sensing station at a candidate site pᵢ in the workspace is able to sense or communicate with each sensed station at the target sites in set Rᵢ belonging to set family [symbol] . Then the step to choose the placement sites from the set of candidate sites {p₁, p₂, . . . , pₘ} for the sensing stations in the workspace is performed by computing a minimum linked-guard-cover for set system Σ={X, [symbol] }.

As taught earlier, the minimum linked-guard-cover can be computed using the popular Greedy algorithm, or a variation thereof, or any other suitable algorithm appropriate for the application at hand. Further, the specification above teaches the custom Greedy algorithm according to the present invention that can be used to determine the minimum linked-guard cover. It should be noted that the invention is not restrictive of a particular algorithm for the computation of a minimum linked-guard-cover, but while several embodiments are taught in this specification, other variations and ways and algorithms to practice the instant invention are entirely possible, within the scope of the invention.

In view of the above teaching, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A system of determining a set of placement sites from a set of candidate sites for at least one sensing station, comprising:
a) at least one target site;
b) zero or more obstructions;
c) at least one sensing region around each said at least one sensing station, where a site b is in said sensing region if said at least one sensing station is able to, one of sense said site b and communicate with a sensed station at said site b, notwithstanding said obstructions;
wherein said set of placement sites is chosen from said set of candidate sites as a minimum linked-guard-cover.

2. The system of claim 1, further comprising at least one sensed station, each said sensed station able to be placed at said target site.

3. The system of claim 2, wherein said at least one sensed station merely represents the location of its corresponding target site.

4. The system of claim 1, further comprising a sensing range and a sensing orientation of said at least one sensing station constraining its said at least one sensing region.

5. The system of claim 1, further comprising a composite sensing region of said at least one sensing station, as a collection of all said sensing region(s) of element (c).

6. The system of claim 5, wherein said composite sensing region is derived as a member of the group consisting of a union, an intersection, and a set operation, of said sensing region(s) of said element (c).

7. The system of claim 1, further comprising a set family of ranges with cardinality same as the set of all said candidate sites, and whose union is the set of all said target site(s), and said at least one sensing station at a candidate site correspondent to a given range is able to, one of sense each said target site(s) in said given range, and communicate with each sensed station(s) placed at said target sites(s) in said given range.

8. The system of claim 7 wherein said minimum linked-guard-cover is derived for the set system comprising the set of said target site(s) and said set family or ranges.

9. The system of claim 1 further operating in a workspace, said workspace selected from the group consisting of a continuous workspace and a discretized workspace.

10. The system of claim 9, wherein the set of said target sites represents the entirety of said workspace.

11. The system of claim 1, wherein the placing of said at least one sensing station at said placement sites guarantees one of, each said at least one target site is able to be sensed by two or more said at least one sensing stations, and each sensed station when placed at each said at least one target site is able to be communicated with, by two or more said at least one sensing stations.

12. The system of claim 1, wherein each said candidate site further comprises the n-dimensional coordinates of the location of said candidate site and said sensing orientation in n-dimensions of said at least one sensing station at said location, where n is a whole number greater than 1.

13. The system of claim 1, wherein each said candidate site further comprises the n-dimensional coordinates of the location of said candidate site, and said sensing orientation in n-dimensions of said at least one sensing station at said location, is unconstrained.

14. The system of claim 1, wherein there is a predetermined number of said at least one sensing stations.

15. The system of claim 1, wherein the locations of said placement sites in said workspace can only be chosen from a predetermined set of locations.

16. The system of claim 1, wherein the locations of said placement sites in said workspace can only exist in one or more predetermined regions.

17. The system of claim 1, wherein said candidate sites aone of overlap and do no overlap, with said target sites.

18. The system of claim 1, wherein said minimum linked-guard-cover is derived from a Greedy algorithm solution.

19. The system of claim 1, wherein said minimum linked-guard-cover is derived from a polynomial-time solution.

20. The system of claim 1, further determining a minimum spanning tree (MST) of the graph of said placement sites in said linked-guard-cover.

21. The system of claim 1, further determining a tree from the graph of said placement sites in said linked-guard-cover.

22. The system of claim 1, wherein said at least one sensing station comprises wireless sensor(s) operating substantially at a frequency of 60 GHz.

23. The system of claim 1, wherein said at least one sensing station comprises a camera and said target site(s) represent objects of interest in a video.

24. The system of claim 23, wherein each said camera appears in the footage of other cameras.

25. The system of claim 1, wherein said at least one sensing station represents a person in a social graph.

26. The system of claim 1, wherein said at least one sensing station is selected from the group consisting of living beings and objects, and said candidate sites and said at least one target site comprise geo-location coordinates.

27. A system of determining a set of placement sites from a set of candidate sites {p₁, p₂, . . . , pₘ} for at least one sensing station, comprising:
a) at least one sensed station, each said sensed station able to be placed at a target site, said target sites represented by set X;
b) zero or more obstructions;
c) at least one sensing region νₖ(p) around each said at least one sensing station when said sensing station is at a candidate site p, where a site b is in said sensing region νₖ(p) if said at least one sensing station is able to, one of sense and communicate with, said sensed station at said site b, notwithstanding said obstructions;
d) a sensing range and a sensing orientation of said at least one sensing station constraining its said at least one sensing region νₖ(p);
e) a composite sensing region ν(p) of each said at least one sensing station at said candidate site p, as a collection of all said k sensing regions νₖ(p);
f) a set family [symbol] ={R₁, R₂, . . . , Rₘ} whose union is said set X and said at least one sensing station at a candidate site pᵢ is able to, one of sense and communicate with, each said at least one sensed station at said target site(s) in set Rᵢ;
wherein said set of placement sites is chosen from said set of candidate sites {p₁, p₂, . . . , pₘ} as a minimum linked-guard-cover for set system Σ={X, [symbol] }.

28. A method for determining a set of placement sites from a set of candidate sites for at least one sensing station, comprising the steps of:
a) providing one or more target sites;
b) providing zero or more obstructions;
c) providing at least one sensing region νₖ(p) around said at least one sensing station when said sensing station is at a candidate site p, and setting said sensing region νₖ(p) to be a collection of all sites b such that said at least one sensing station is able to, one of sense any of said sites b and communicate with a sensed station at any of said sites b, notwithstanding said obstructions; and
choosing said placement sites from said set of candidate sites based on a minimum linked-guard-cover.

29. The method of claim 28 further providing a composite sensing region ν(p) for said at least one sensing station at said candidate site p, to be a collection of all said k sensing regions νₖ(p).

30. The method of claim 29 further determining said minimum linked-guard cover utilizing the steps of:
a) Initializing a set P equal to said set of candidate sites, a set X equal to said one or more target sites, and said minimum linked-guard-cover to an empty set;
b) Selecting candidate site sεP with the most number of said target site(s) in said sensing region ν(s), such that if said minimum linked-guard-cover is not an empty set, then at least one member of said minimum linked-guard-cover is also in said sensing region ν(s);
c) Deleting said target site(s) in said sensing region ν(s) of step (b) above, from said set X;
d) Deleting said candidate site s from said set P;
e) Adding said candidate site s to said minimum linked-guard-cover; and
f) Repeating steps (b) through (e) above until said set X becomes empty.
